(19) United States
(12) Patent Application Publication
(10) Pub. No.: US 2022/0300798 A1
(43) Pub. Date: Sep. 22, 2022

(54) OPTICAL DEVICES AND METHODS

(71) Applicant: Oxford University Innovation Limited, Oxford (Oxfordshire) (GB)

(72) Inventors: James Tan You SIAN, Oxford (Oxfordshire) (GB); Zengguang CHENG, Oxford (Oxfordshire) (GB); Harish BHASKARAN, Oxford (Oxfordshire) (GB)

(21) Appl. No.: 17/618,648

(22) PCT Filed: Jun. 4, 2020
(86) PCT No.: PCT/GB2020/051358

§ 371 Date: Dec. 13, 2021

(30) Foreign Application Priority Data
Jun. 19, 2019 (GB) 1908760.0

(51) Int. Cl. G06N 3/067; G02F 1/035; G06N 3/04

(52) U.S. Cl. CPC G06N 3/0675; G02F 1/0356; G06N 3/0445

(57) ABSTRACT

An optical associative learning element (200) comprising a first waveguide (202), a second waveguide (204) and a modulating element (206), wherein: a cascaded first (208) and second (210) directional coupler are formed from a portion (212) of the first (202) and second (204) waveguides in which the first (202) and second (204) waveguides are substantially parallel, evanescently coupled and separated by a gap; the modulating element (206) is evanescently coupled to the second waveguide (204) in the second directional coupler (210) and is arranged to modify a transmission or absorption characteristic of the second waveguide (204) dependent on the state of the modulating element (206); and the state of the modulating element (206) is adjustable between a first and second state by an optical field carried by the first (202) and/or second (204) waveguide.

### TECHNICAL FIELD

The present disclosure relates to an optical associative learning element and a method of performing an associative learning operation in the optical domain using the optical associative learning element.

### BACKGROUND

Artificial intelligence (AI) seeks to build, engineer, control and design neuromorphic networks that are on par with or perhaps even more elegant than biological neural networks in nature. Such associative learning in the form of classical conditioning is often linked with the ability of humans and animals to solve complex multivariate problems with relative ease. Inspired by the same principles, associative learning have been used to augment human work by taking advantage of statistical data inputs that occur simultaneously and thereby forming associations between them.

In autonomous systems, associative learning has been explicitly used to provide machine learning capabilities, for example, the aptitude to predict rare events from temporal and sequential patterns of timestamped observations. The ability to associate can also facilitate sophisticated machine intelligence with a vast array of data analytic applications such as predicting telecommunication equipment failures and mitigating credit card transaction frauds.

On a larger scale, based on one example machine learning architecture (see U.S. Pat. No. 5,588,091, issued Dec. 24, 1996), the computational effort of artificial neural networks using associative learning elements as building blocks scales linearly with the number of connections, in contrast to the non-linear scaling in the conventional Hebbian learning-based networks. Given the typically large datasets necessary in machine learning, this can substantially downscale the training time, energy usage and network size.

Accordingly it is an object of the present disclosure to provide an associative learning element capable of input data association.

The project leading to this application has received funding from the European Union's Horizon 2020 research and innovation programme under grant agreement No 780848.

### SUMMARY OF DISCLOSURE

According to a first aspect of the present disclosure there is provided an optical associative learning element comprising a first waveguide, a second waveguide and a modulating element, wherein:
a cascaded first and second directional coupler are formed from a portion of the first and second waveguides in which the first and second waveguides are substantially parallel, evanescently coupled and separated by a gap;
the modulating element is evanescently coupled to the second waveguide in the second directional coupler and is arranged to modify a transmission or absorption characteristic of the second waveguide dependent on the state of the modulating element; and
the state of the modulating element is adjustable between a first and second state by an optical field carried by the first and/or second waveguide.

The first state may comprise a crystalline state of the modulating element. The second state may comprise a less crystalline state, e.g. an amorphous state, of the modulating element. The second state may be a state in which a fractional volume of the modulating element is amorphous and the remaining volume of the modulating element is crystalline. The fractional volume of the modulating element which is amorphous may be larger in the second state than in the first state.

Implementing the associative learning element on an optical platform offers the advantage of broad bandwidth, and power-efficient data transmission using CMOS-compatible fabrication process. Further, photonic networks are inherently scalable and therefore well-suited to implementing an on-chip artificial neural network based on interlinked associative learning elements according to the first aspect.

In some embodiments, the modulating element is configured to modify the amount of coupling between the first and second waveguides in the second directional coupler dependent on the state of the modulating element.

In some embodiments, the modulating element is not evanescently coupled to the second waveguide in the first directional coupler. For example, the modulating element may only extend over the second waveguide in the portion of the second waveguide corresponding to the second directional coupler.

In some embodiments, the first directional coupler is arranged such that when a first optical field is carried by the first waveguide in the absence of a second optical field being contemporaneously carried by the second waveguide, the residual intensity of the first optical field in the first waveguide at the interface between the first and second directional couplers is at least half the initial intensity of the first optical field, preferably greater than 80% of the initial intensity of the first optical field.

In other words, the first directional coupler is arranged to minimize single-input coupling between the first and second waveguides in the first directional coupler.

In some embodiments, the second directional coupler is arranged such that:
when the modulating element is in the first state, the first waveguide provides a first output intensity I₁ when an optical field having intensity I₀ is introduced into the first waveguide prior to the first directional coupler, and a second output intensity I₂ when an optical field having intensity I₀ is introduced into the second waveguide prior to the first directional coupler; and
when the modulating element is in the second state, the first waveguide provides a third output intensity I₃ when an optical field having intensity I₀ is introduced into the first waveguide prior to the first directional coupler, and a fourth output intensity I₄ when an optical field having intensity I₀ is introduced into the second waveguide prior to the first directional coupler,
wherein the magnitude of the difference between I₄ and I₃, |I₄−I₃|, is less than the magnitude of the difference between I₂ and I₁, |I₂−I₁|.

In some embodiments, the magnitude of the difference between I₄ and I₃ is less than or equal to 10% of the magnitude of the difference between I₂ and I₁, preferably less than or equal to 5% of the magnitude of the difference between I₂ and I₁, more preferably less than or equal to 1% of the magnitude of the difference between I₂ and I₁.

This is indicative of the modulating element regulating the output response of the learning element. The second state may be equivalent to a ‘post-learning’ (trained) state and the first state may be equivalent to a ‘before learning’ (untrained) state of the learning element. In the post-learning state, two similar optical input fields incident separately in the first and second waveguides of the modulating element may produce similar outputs from the first waveguide after the second directional coupler. On the contrary, in the before learning state the same two optical input fields may produce dissimilar outputs from the first waveguide after the second directional coupler. The two input fields may be analogous to unconditioned (UCS) and neutral/conditioned stimuli (NS/CS) as per classical conditioning. The output of the first waveguide after the second directional coupler may be analogous to the response (R) of the learning element, which is modulated by the modulating element.

In some embodiments, the first and second directional couplers are arranged such that the state of the modulating element can be switched from said first state to said second state by introducing a first optical field into the first waveguide contemporaneously with a second optical field into the second waveguide.

In some embodiments, the first optical field comprises a first optical pulse or a train of first optical pulses and the second optical field comprises a second optical pulse or a train of second optical pulses, wherein the first optical pulse or pulses are temporally overlapped with the second optical pulse or pulses in the first directional coupler. The first and second optical pulses may have a defined optical phase delay between them, such as, for example, a temporal delay in the range 0.66 fs to 1.155 fs, e.g. 0.825 fs for the waveguide structures of effective refractive index n_{eff}=1.59 at optical wavelength 1580 nm. This corresponds to a phase offset/delay in the range 0.4π radians to 0.7π radians, e.g. 0.5π radians.

In some embodiments, the modulating element comprises a phase change material.

In some embodiments, the modulating element comprises a material comprising a compound or alloy of a combination of element selected from the following list of combinations: GeSbTe, VOₓ, NbOₓ, GeTe, GeSb, GaSb, AgInSbTe, InSb, InSbTe, InSe, SbTe, TeGeSbS, AgSbSe, SbSe, GeSbMnSn, AgSbTe, AuSbTe, and AlSb.

In some embodiments, the second waveguide is tapered in the portion corresponding to the second directional coupler, such that a width of the second waveguide in the first directional coupler is greater than a corresponding width of the second waveguide in the second directional coupler.

In some embodiments, the width of the second waveguide in the first directional coupler is in the range 1.05 μm to 1.15 μm and the width of the second waveguide in the second directional coupler is in the range 0.95 μm to 1.04 μm and the second waveguide tapers over a distance in the range 0.4 μm to 0.6 μm.

In some embodiments, the length of the first directional coupler is in the range 1.5 μm to 3.0 μm and the length of the second directional coupler is in the range 10 μm to 20 μm. The ratio of the length of the first directional coupler to the length of the second directional coupler may be in the range 0.05 to 0.30.

In some embodiments, the gap between the first and second waveguides is in the range 0.05 μm to 0.15 μm.

It should be appreciated that the dimensions disclosed herein are exemplary only. The dimensions will in general depend on the effective refractive indices of the first and second waveguides that form the first and second directional couplers.

According to a second aspect of the present disclosure there is provided a photonic chip comprising:
the optical associative learning element according to the first aspect;
an input coupler for coupling optical fields into the photonic chip; and
a splitter arranged to divide an output of the input coupler into first and second spatial paths on the photonic chip, wherein
the first spatial path is coupled to the first waveguide of the optical associative learning element and the second spatial path is coupled to the second waveguide of the optical associative learning element, and
the first and second spatial paths are arranged to introduce an optical phase delay between optical fields arriving at the first directional coupler of the optical associative learning element.

The optical phase delay introduced by the first and second spatial paths on the photonic chip may be in the range 0.66 fs to 1.155 fs, e.g. 0.825 fs. This corresponds to a phase offset/delay in the range 0.4π radians to 0.7π radians, e.g. 0.5π radians.

In some embodiments, the optical phase delay and the first directional coupler are arranged such that optical intensity is accumulated in the second waveguide at the interface between the first and second directional couplers of the learning element when both the first and second waveguides carry optical fields contemporaneously. The optical phase delay and the first directional coupler may be arranged to maximise the accumulated optical intensity.

In this manner, when the first and second optical fields, e.g. representative of UCS and NS/CS inputs, are incident together into the optical associative learning element, optical intensity is accumulated in the second waveguide which can lead to switching of the state of the modulating element from e.g. a crystalline state to a less crystalline/amorphous state. This results in a change of the output response R of the learning element such that UCS and NS/CS single inputs result in a similar output after the state of the modulating element has been switched, which is indicative of associative learning.

In some embodiments, the optical phase delay and the first directional coupler are together arranged such that when a first optical field is carried by the first waveguide and contemporaneously a second optical field is carried by the second waveguide, the first directional coupler transfers at least a portion, e.g. at least 10% or at least 20% or at least 50% or at least 80%, of the initial intensity of the first optical field from the first waveguide to the second waveguide, such that the total optical intensity in the second waveguide at the interface between the first and second directional couplers is greater than the total optical intensity in the second waveguide at the start of the first directional coupler.

The portion of the intensity of the second optical field transferred from the second waveguide to the first waveguide may be less than 10%, e.g. less than 5% or more preferably less than 1%. In other words, in the first directional coupler, the total optical intensity associated with first and second optical fields carried by the first and second waveguides respectively is substantially accumulated in the second waveguide at the interface between the first and second directional couplers. For example, at least 80% of the total intensity may be accumulated in the second waveguide, preferably at least 90%, more preferably at least 95%.

According to a third aspect of the present disclosure there is provided an optical system comprising:
the photonic chip according to the second aspect;
a light source coupled to the input coupler and arranged to provide optical fields to the optical associative learning element via the first and second spatial paths; and
a detector arrangement coupled to the first waveguide of the optical associative learning element at the output of the second directional coupler thereof.

In some embodiments the light source comprises a first laser, a second laser and an optical combiner.

In some embodiments, the first laser is arranged to produce first optical pulses having a first wavelength and the second laser is arranged to produce second optical pulses having a second wavelength, different from the first wavelength.

In some embodiments, the optical combiner is arranged to receive the first and second optical pulses from the first and second lasers and combine them into a common spatial mode.

In some embodiments, an output of the optical combiner is coupled to the input coupler of the photonic chip.

In some embodiments, the first and second spatial paths on the photonic chip comprise a first ring resonator and a second ring resonator respectively.

In some embodiments, the first ring resonator is arranged to select said first wavelength from said first portion and the second ring resonator is arranged to select said second wavelength from said second portion.

In some embodiments, the outputs of the first and second ring resonators are coupled to the first and second waveguides respectively of the optical associative learning element, prior to the first directional coupler.

In some embodiments, the detector arrangement comprises a beam splitter, a first optical tuneable filter, a second optical tuneable filter, a first photodiode and a second photodiode.

In some embodiments, the beam splitter is arranged to split the optical intensity from the first waveguide into a first spatial mode and a second spatial mode.

In some embodiments, the first optical tuneable filter is arranged to select the first wavelength in the first spatial mode and the second optical tuneable filter is arranged to select the second wavelength in the second spatial mode.

In some embodiments, the first photodiode is arranged to detect optical intensity after the first optical tuneable filter and the second photodiode is arranged to detect optical intensity after the second optical tuneable filter.

In some embodiments, the optical system further comprises a controller arranged to control the light source to produce a pre-determined sequence of optical fields.

In some embodiments, the controller is further arranged to receive one or more readouts from the detector arrangement.

In some embodiments, the controller is further arranged to determine a learning status of the optical associative learning element based on the one or more readouts.

In some embodiments, the light source further comprises a third laser arranged to provide optical pump pulses for resetting the state of the modulating element to a predetermined state, thereby undoing a prior training process of the optical associative learning element.

In some embodiments, the controller is arranged to determine a learning status of the optical associative learning element by controlling the light source to transmit first and second optical fields having first and second wavelengths through the first and second waveguides respectively and monitoring the output of the detector arrangement and determining therefrom optical transmittance factors of the first and second optical fields through the optical associative learning element.

In some embodiments, the controller is arranged to determine that the optical associative learning element is in a trained state if the optical transmittance factors of the first and second optical fields through the optical associative learning element are within 10% of each other, preferably if they are within 5% of each other.

According to a fourth aspect of the present disclosure, there is provided an optical artificial neural network, comprising a plurality of optical associative learning elements according to the first aspect, wherein at least two of the optical associative learning elements are coupled together.

In some embodiments, the output of the first waveguide of a first one of the plurality of optical associative learning elements is coupled to the input of the first or second waveguide of a second one of the plurality of optical associative learning elements.

In some embodiments, the optical artificial neural network further comprises a controller configured to implement a pattern recognition algorithm on the optical artificial neural network.

According to a fifth aspect of the present disclosure, there is provided a method of performing an associative learning operation in the optical domain using an optical associative learning element according to the first aspect, the method comprising: providing first and second optical fields contemporaneously to the first and second waveguides respectively thereby modifying a state of the modulating element.

In some embodiments, modifying a state of the modulating element comprises changing the state of the modulating element from a more crystalline state to a less crystalline state, such as an amorphous state.

In some embodiments, the first directional coupler accumulates optical intensity associated with the first and second optical fields in the second waveguide at the interface between the first and second directional couplers.

In some embodiments, the method further comprises selecting a relative phase delay between the first and second optical fields in order to maximize an accumulated optical intensity in the second waveguide at the interface between the first directional coupler and the second directional coupler.

In some embodiments, the step of selecting a relative phase delay comprises performing a numerical simulation of the device in order to determine an optimal value of the relative phase delay.

In some embodiments, the step of selecting a relative phase delay comprises configuring a light source to provide first and second optical fields having a defined phase delay to each other, e.g. the optimal phase delay, to the first and second waveguides of the learning element respectively.

In some embodiments, the method further comprises determining a learning status of the device by determining optical transmittance factors through the device for optical fields coupled to inputs of the first and second waveguides.

In some embodiments, the device is deemed to be in a trained state if said optical transmittance factors are within 10% of each other, preferably within 5% of each other.

In some embodiments, the method further comprises resetting the device by providing pump optical pulses to the second waveguide in order to crystallise the modulating element.

According to a sixth aspect of the present disclosure, there is provided a system comprising an optical associative learning element according to the first aspect coupled to a light source, wherein the light source is operable to provide first and second optical fields to the first and second waveguides of the first directional coupler, the first and second optical fields having a pre-determined relative phase delay between them, wherein the relative phase delay and the first directional are together arranged such that optical intensity is accumulated in the second waveguide at the interface between the first and second directional couplers.

In this manner, when the first and second optical fields, e.g. representative of UCS and NS/CS inputs, are incident together into the optical associative learning element, optical intensity is accumulated in the second waveguide which can lead to switching of the state of the modulating element from e.g. a crystalline state to a less crystalline/amorphous state. This results in a change of the output response R of the learning element such that UCS and NS/CS single inputs result in a similar output after the state of the modulating element has been switched.

The light source may comprise a controller which is operable to adjust the relative phase delay between the first and second optical fields.

The light source may comprise a first and second phase-locked lasers and a phase modulator operable to adjust the relative phase delay between outputs of the first and second lasers to provide said first and second optical fields to the learning element.

The relative phase delay may be in the range 0.66 fs to 1.155 fs, e.g. 0.825 fs. This corresponds to a phase offset/delay in the range 0.4π radians to 0.7π radians, e.g. 0.5π radians.

The system may further comprise a detector arrangement coupled to the first waveguide of the optical associative learning element at the output of the second directional coupler thereof.

The system may further comprise a controller arranged to control the light source to produce a pre-determined sequence of optical fields. The controller may also be arranged to monitor an output of the detector arrangement, e.g. to determine a learning status of the learning element.

The features (including optional features) of any aspect may be combined with those of any other aspect, as appropriate.

### BRIEF DESCRIPTION OF THE DRAWINGS

Example embodiments will be described, by way of example only, with reference to the drawings, in which:

FIG. 1 illustrates an associative learning process known as classical conditioning;

FIG. 2 illustrates an optical associative learning element according to the present disclosure;

FIGS. 3A and 3B illustrate the optical associative learning element according to the present disclosure in the “before learning” state and in the “after learning” state respectively;

FIG. 4 illustrates an optical system according to the present disclosure which comprises a light source, a detector and a photonic chip containing an optical associative learning element;

FIGS. 5A to 5C show simulation results of associative learning with an optical associative learning element according to the present disclosure;

FIGS. 6A to 6C show experimental results of associative learning with an optical associative learning element according to the present disclosure;

FIGS. 7A and 7B illustrate schematically input-input synaptic plasticity of associative learning according to the present disclosure;

FIG. 8 illustrates schematically two input optical fields UCS and CS incident onto the optical associative learning element according to the present disclosure, and highlights the representation of the relative optical delay Δt.

FIG. 9 shows the dependence on Δt of the optical intensity accumulated in the second waveguide at the interface between the first and second directional couplers in an optical associative learning element according to the present disclosure;

FIG. 10 illustrates schematically in detail an optical setup to characterize an optical associative learning element according to the present disclosure;

FIGS. 11A to 11D illustrate aspects of a photonic chip including an optical associative learning element according to the present disclosure;

FIGS. 12A and 12B show results of simulations using coupled-mode theory to investigate the accumulation of optical intensity as a function of coupler length in an optical associative learning element according to the present disclosure;

FIGS. 13A and 13B show transmission spectra of different wavelengths through an optical associative learning element according to the present disclosure;

FIGS. 14A and 14B show results of simulations to investigate the influence of differing Δt on the accumulation of optical intensity in the first directional coupler of an optical associative learning element according to the present disclosure;

FIG. 15 show the simulated electric field profile as a function of Δt at the interface between the first and second directional coupler of an optical associative learning element according to the present disclosure;

FIGS. 16A to 16C show simulation results of a two-way associative learning process within an optical associative learning element according to the present disclosure;

FIG. 17A illustrates an example of a scheme to artificially implement the spike-based formulation of the Hebbian learning rule, known as spike-timing dependent plasticity (STDP); and

FIG. 17B illustrates a type of artificial neural network based on associative learning.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION

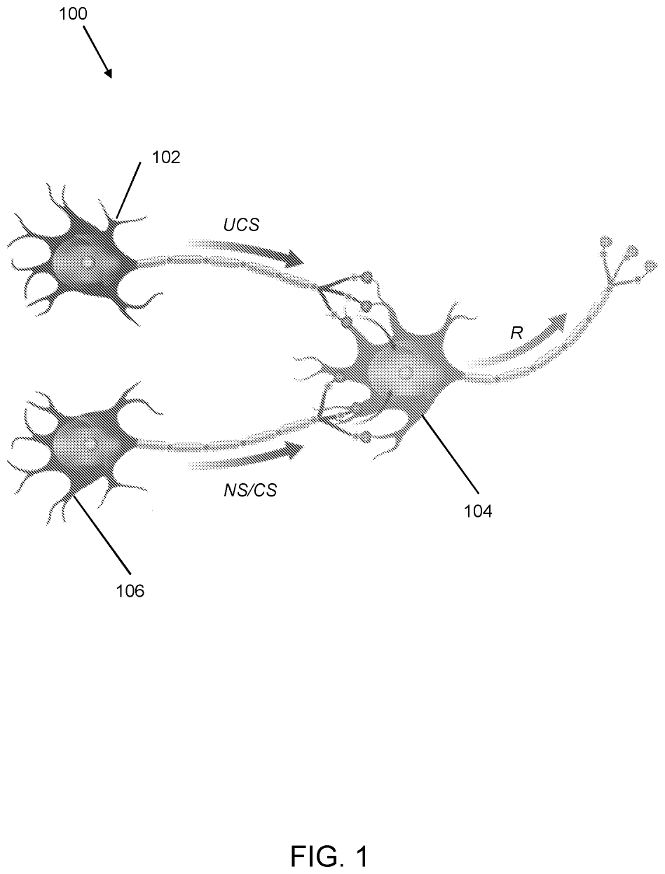

FIG. 1 illustrates an associative learning process, known as classical conditioning, within a biological system 100. The unconditioned stimulus UCS is the input from a sensory neuron 102 that naturally triggers a particular response R from the motor neuron 104. The neutral stimulus NS is the input from another sensory neuron 106 that does not trigger the response R until it is paired with the UCS. After the temporal pairing, the response R is triggered when either the UCS or the conditioned stimulus CS (previously NS) is sent to the motor neuron 104.

Classical conditioning was initially described in Ivan Pavlov's dog experiment in 1927. In the experiment, food was the UCS that triggered an unconditioned response (UCR) i.e., the dog's salivation; while the ringing bell sound was the NS or CS. The bell (NS/CS) only triggered the salivation response R after the ringing bell was associated by repletion with food. Thus, these initially distinct responses eventually converged to a single response after similar stimuli co-occurrence, which associated the stimuli.

Two main roles of the simplified neural circuitry of FIG. 1 can be identified: to converge and associate the two inputs, viz. the UCS and NS/CS sensory inputs, as well as to store memories of these associations which are critical for the generation of the output reaction that defines the learning process.

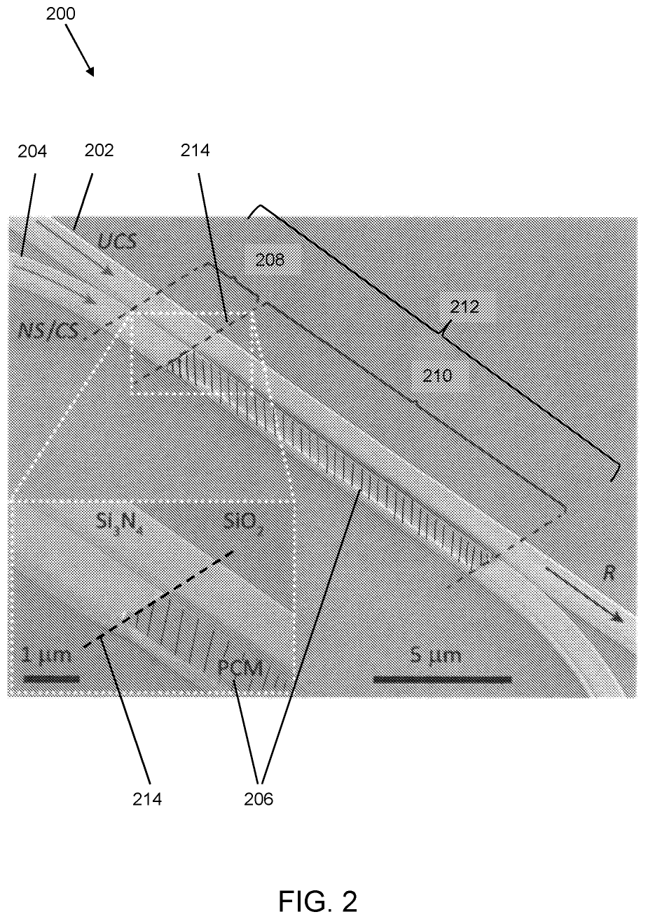

According to the present disclosure, with reference to FIG. 2, these two complementary roles are implemented in an optical associative learning element 200. The optical associative learning element 200 comprises a first waveguide 202, a second waveguide 204 and a modulating element 206. Cascaded first and second directional couplers, 208 and 210 respectively, are formed from a portion 212 of the first 202 and second 204 waveguides in which the first 202 and second 204 waveguides are substantially parallel, evanescently coupled and separated by a gap. The modulating element 206 is evanescently coupled to the second waveguide 204 in the second directional coupler 210 and is arranged to modify a transmission or absorption characteristic of the second waveguide 204 dependent on the state of the modulating element 206. In the illustrated embodiment the modulating element 206 does not extend over the portion of the second waveguide 204 corresponding to the first directional coupler 208. The state of the modulating element 206 is adjustable by an optical field carried by the first 202 and/or second 204 waveguide at the interface 214 between the first 208 and second 210 directional couplers. The modulating element 206 is able to modify the amount of coupling between the first 202 and second 204 waveguides in the second directional coupler 210 dependent on the state of the modulating element 206.

The optical associative learning element 200 is arranged to accumulate optical intensity in the second waveguide 204 at the interface 214 between the first 208 and second 210 directional couplers when both the first 202 and second 204 waveguides carry optical fields contemporaneously, i.e. when the optical fields carried by the first 202 and second 204 waveguides are substantially overlapping in time. For example, the first directional coupler 208 is arranged such that when a first optical field is carried by the first waveguide 202 and contemporaneously a second optical field is carried by the second waveguide 204, the first directional coupler 208 transfers at least a portion of the intensity of the first optical field from the first waveguide 202 to the second waveguide 204, such that the total optical intensity in the second waveguide 204 at the interface 214 between the first 208 and second 210 directional couplers is greater than the total optical intensity in the second waveguide 204 at the start of the first directional coupler 208.

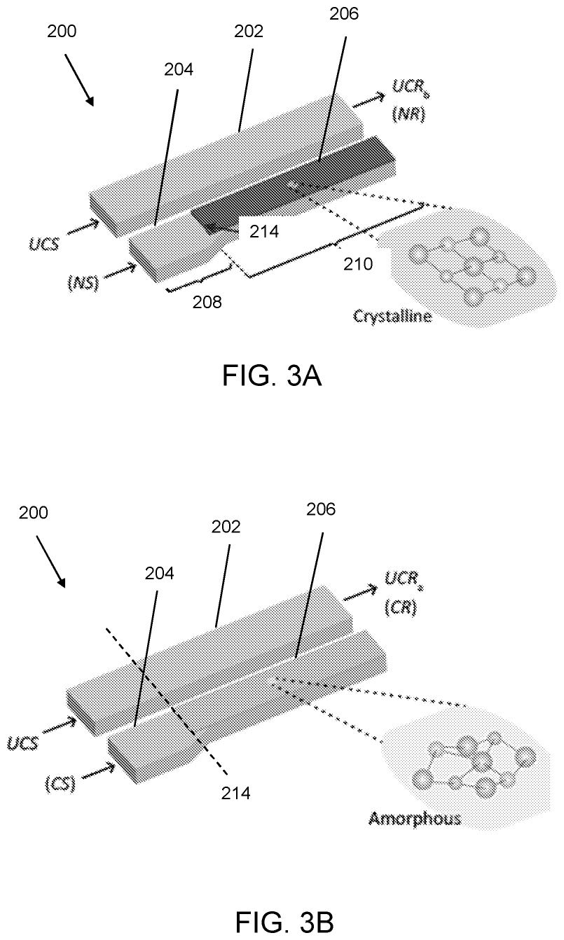

In this manner, the net optical energy/intensity from both the inputs (UCS and NS/CS) is converged in the lower waveguide 204 of the first coupler 208. This can cause a fractional volume of the modulating element 206 to be switched to a different state. For example, the modulating element may comprise a phase change material (PCM) and the converged optical energy/intensity causes a fractional volume of the modulating element 206 to be switched from a crystalline state to an amorphous state. With more converging learning optical fields (e.g. pulses), a larger volume of material of the modulating element 206 switches from crystalline to amorphous which could be considered to correspond to a switching from a “before learning” state to an “after learning state”. This is illustrated in FIGS. 3A and 3B, where FIG. 3A illustrates schematically the optical associative learning element 200 in the “before learning” (e.g. crystalline) state and FIG. 3B illustrates schematically the learning element 200 in the “after learning” state (e.g. amorphous).

In some embodiments, the PCM 206 deposited on the second waveguide 204 is a germanium antimony tellurium alloy Ge₂Sb₂Te₅ (GST). In general, the modulating element 206 comprises a material comprising a compound or alloy of a combination of element selected from the following list of combinations: GeSbTe, VOx, NbOx, GeTe, GeSb, GaSb, AgInSbTe, InSb, InSbTe, InSe, SbTe, TeGeSbS, AgSbSe, SbSe, GeSbMnSn, AgSbTe, AuSbTe, and AlSb. GST is well-suited as it has a low structural phase transition time (sub-ns amorphization and few-ns crystallization time), high cycling endurance (˜10¹² cycles), and long retention time (>10 years at room temperature). In some embodiments, a thin capping layer of indium tin oxide (ITO) may be additionally deposited on the PCM cell to prevent oxidation, and to localize optically-induced heat for PCM structural phase switching.

The first directional coupler 208 performs the function of determining the input optical intensity combinations (input to the first 202 and second 204 waveguides) that sufficiently trigger the associative learning process. Meanwhile, the second directional coupler 210 regulates the output response R which is measured from the output of the first waveguide 202. The lower (second) waveguide 204 of the first directional coupler 208 is the site where optical energy from the UCS and NS/CS inputs accumulates for structural phase switching to occur in the modulating element 206, thereby regulating the output response R. It is desirable that the optical associative learning element 200 associatively learns only upon two-input incidence, i.e. when optical fields are present in the first 202 and second waveguides 204 contemporaneously. As mentioned above, the first directional coupler 208 is configured to accumulate optical intensity in the lower waveguide 204 at the interface 214 for switching the state of the modulating element 206—which constitutes the learning process. The regulation of the output response R is performed by the second coupler 210. This is measured upon one-input incidence, i.e. a single optical field incident either in the first waveguide 202 or the second waveguide 204.

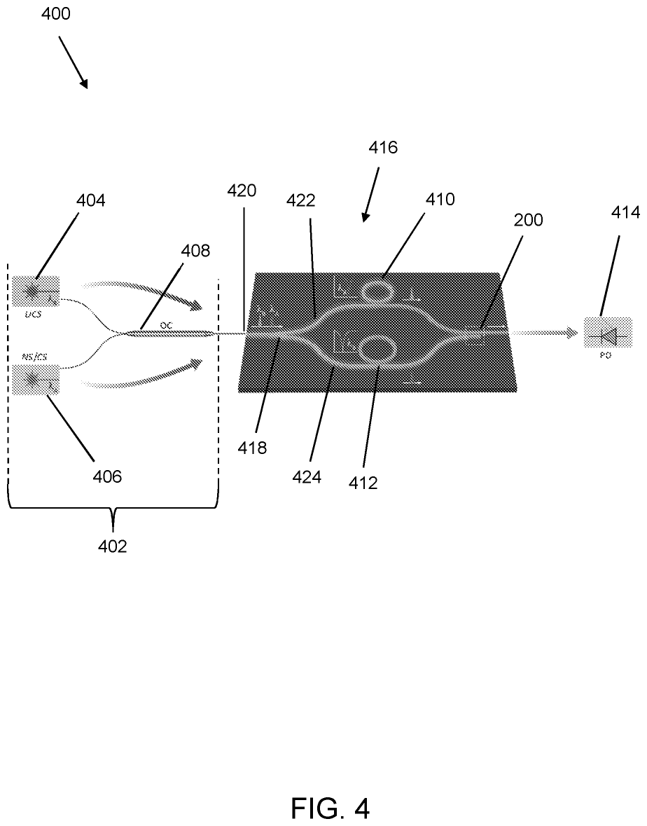

FIG. 4 illustrates an optical system 400 comprising an optical associative learning element 200 according to the present disclosure. A light source 402 is coupled to a photonic chip 416 which comprises the optical associative learning element 200. A detector arrangement 414, which may or may not form part of the photonic chip 416, is coupled to the first waveguide 202 of the learning element 200 at the output of the second directional coupler 210. The detector is used to determine the response R. The photonic chip 416 has an input coupler 420 for coupling optical fields into the photonic chip 416 and an optical splitter 418 which is arranged to divide the output of the input coupler into first 422 and second 424 spatial paths on the photonic chip. The first spatial path 422 is coupled to the first waveguide 202 of the optical associative learning element 200 and the second spatial path 424 is coupled to the second waveguide 204 of the optical associative learning element 200. The first and second spatial paths 422, 424 are arranged to introduce an optical phase delay between optical fields arriving at the first and second waveguides of the optical associative learning element, which is explained in more detail below.

In embodiments, the photonic chip 416 comprises a first ring resonator 410 and a second ring resonator 412 in the first 422 and second 424 spatial paths respectively. The light source 402 comprises a first laser 404, a second laser 406 and an optical combiner 408. The first laser 404 is arranged to produce first optical pulses having a first wavelength B. The second laser 406 is arranged to produce second optical pulses having a second wavelength A, in general different from the first wavelength. The optical combiner 408 is arranged to receive the first and second optical pulses from the first and second lasers and combine them into a common spatial mode, e.g. in a single fiber optical cable or waveguide. The first ring resonator is arranged to receive a first portion of the output intensity of the optical combiner and the second ring resonator is arranged to receive a second portion of the output intensity of the optical combiner. The first ring resonator is arranged to select said first wavelength from said first portion and the second ring resonator is arranged to select said second wavelength from said second portion. The outputs of the first and second ring resonators are coupled to the first 202 and second 204 waveguides of the learning element 200 respectively, prior to the first directional coupler 208. The first 404 and second 406 lasers represent the UCS and NS/CS stimuli. After passing through the ring resonators, only UCS or NS/CS is selected for each waveguide at the resonant wavelength B or A and sent to the element 200. Thus, control of wavelengths helps regulate the device operation.

The optical phase difference or optical delay between the optical fields carried by the first 202 and second waveguides 204 in the learning element 200 affects how energy is coupled in the first directional coupler 208 and therefore the extent to which optical energy/intensity is accumulated in the lower waveguide 204. The relative time delay of the optical phases between the UCS (upper waveguide 202) and NS/CS (lower waveguide 204) inputs may be denoted Δt+t_{UCS}−t_{NS/CS}, where t_{UCS} and t_{NS/CS} are the times at which the respective optical field input signals UCS and NS/CS are referenced to the same point in phase. In embodiments, phase delay control is achieved using an on-chip photonic layout 416 which contains the learning element 200 in addition to the ring resonators 410, 412 and spatial paths 422 and 424. The layout 416 locks the time delay of the phases (phase delay) as a function of spatial path length difference from the optical splitter 418, contained on the layout 416 and arranged to receive the output of the optical combiner 408, to the first 202 and second 204 waveguide inputs of the element 200. Given the broadband response of the optical element, the relative time delay of the phases to the waveguide inputs of the element can be precisely defined with respect to the input wavelength to the layout. On the other hand, to enable single input incidences to the element, a respective ring resonator 410, 412 is coupled to the two waveguide paths prior to the input ports of the element. The single UCS (NS/CS) input is incident when the input to the on-chip layout is of ring B (A) resonant wavelength λ_{B} (λ_{A}). By precisely defining the optical wavelength of the input laser source, the on-chip layout sorts both the single- and two-input incidences to the element. Simultaneous real-time monitoring of the element is carried out by using a photodetector 414 to measure the output transmission and thereby determine the learning element response R.

Example physical parameters of the learning element 200 were determined using coupled mode theory. The first directional 208 coupler effectively performs the function of determining the input optical field combinations that sufficiently trigger the associative learning process, whilst the second directional coupler 210 is used for regulating the output response R. In other words, two-input coupling to the second waveguide 204 at the interface 214 between the first 208 and second 210 directional couplers should be enhanced and ‘one-input coupling’ from the first waveguide 202 to the second waveguide 204 should be impeded by exploiting the critical coupling length contrast between the one-input case and two-input case. On the other hand, in the second directional coupler 210, the difference in output response R due to the loss contrast between the PCM 206 structural states that represent the before and after learning cases is exploited.

In one example, the first directional coupler 208 has a length of 2 μm and the second directional coupler 210 has a length of 15 μm. The first waveguide 202 is a plain waveguide consistently of nominal width 0.9 μm. In the second waveguide 204, the width of the segment corresponding to the first directional coupler 208 is 0.9 μm, whereas the width of the segment corresponding to the second directional coupler 210 is tapered from 0.9 μm to 0.8 μm. This tapering compensates for the non-zero permittivity of the PCM 206 which contributes to the effective refractive index of the waveguide. The tapering therefore provides optimal inter-waveguide coupling with a waveguide separation gap of 0.1 μm. However, it should be appreciated that the tapering is not essential and the learning element can still function without it. It should be appreciated that the learning element 200 capitalizes on PCM optical loss contrast between the two phases (crystalline and amorphous) to absorb and direct the optical field before and after the learning process. The use of directional couplers ensures the applicability of the element over a broad optical wavelength range.

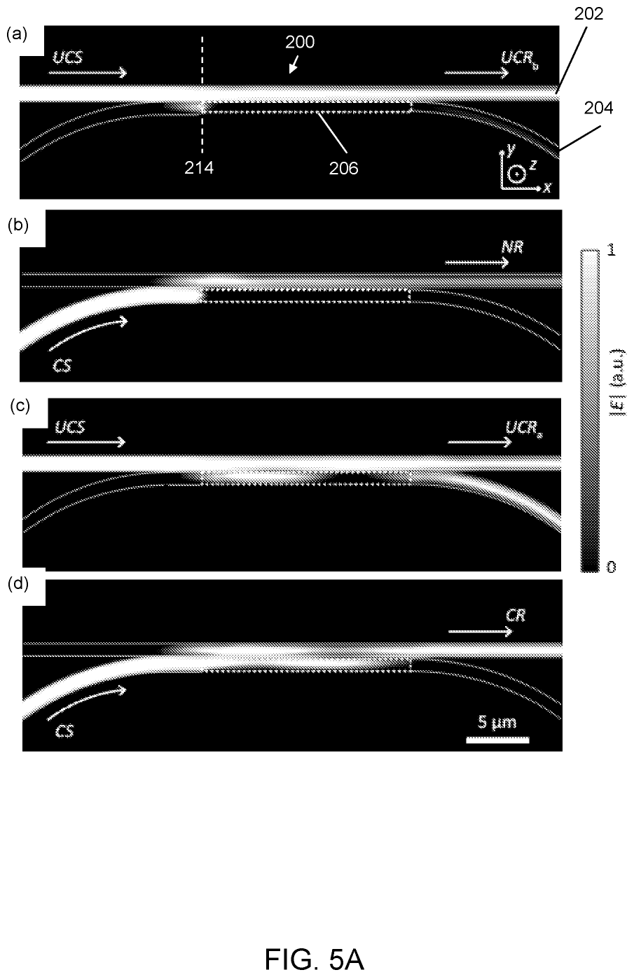

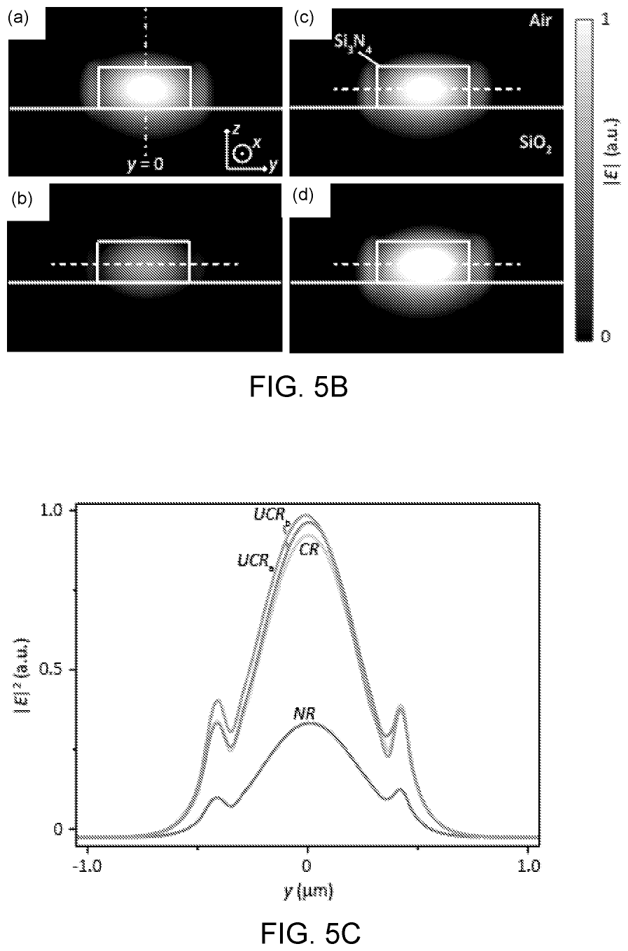

Simulations were performed based on the above exemplary dimensions of the learning element 200 using three-dimensional finite difference time domain FDTD numerical simulation, the results of which are shown in FIGS. 5A-5C. The simulations were performed both before and after learning (crystalline and amorphous PCM 206 respectively) upon transverse electric (TE) optical field input incidence at 1580 nm wavelength. As shown in FIGS. 3A and 3B, before learning, input UCS naturally triggers output UCR_{b} (subscript ‘b’ denotes before learning) while input NS does not trigger a UCR-like output (denoted here as the neutral response NR) until paired with UCS. After learning, input CS, which was input NS before learning, now triggers CR, which is similar to UCRₐ (subscript ‘a’ denotes after learning).

FIG. 5A shows results of input NS/CS→input UCS association according to the simulations. The before learning case is shown in plots (a) and (b), whereas the after learning case is shown in plots (c) and (d). The lighter shades at the output end (right hand side) of the element 200 represents the UCR-like responses. The corresponding output cross-sectional field profiles before and after learning upon UCS and NS/CS input incidence are shown in FIG. 5B plots (a)-(d). From the output cross-sectional curve of intensity |E|² shown in FIG. 5C, the clear contrast between NR and CR/UCR outputs confirms the input NS/CS→input UCS association after learning.

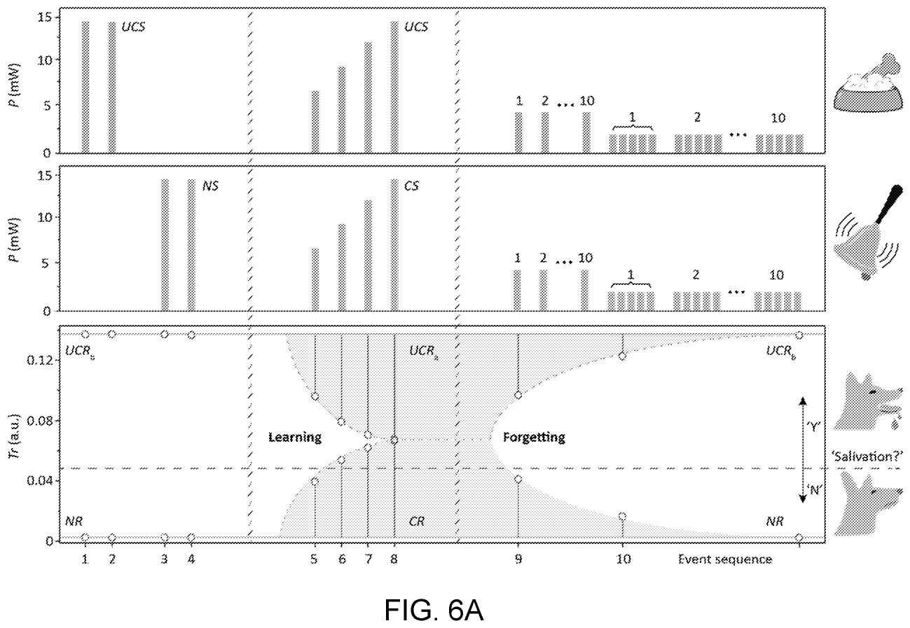

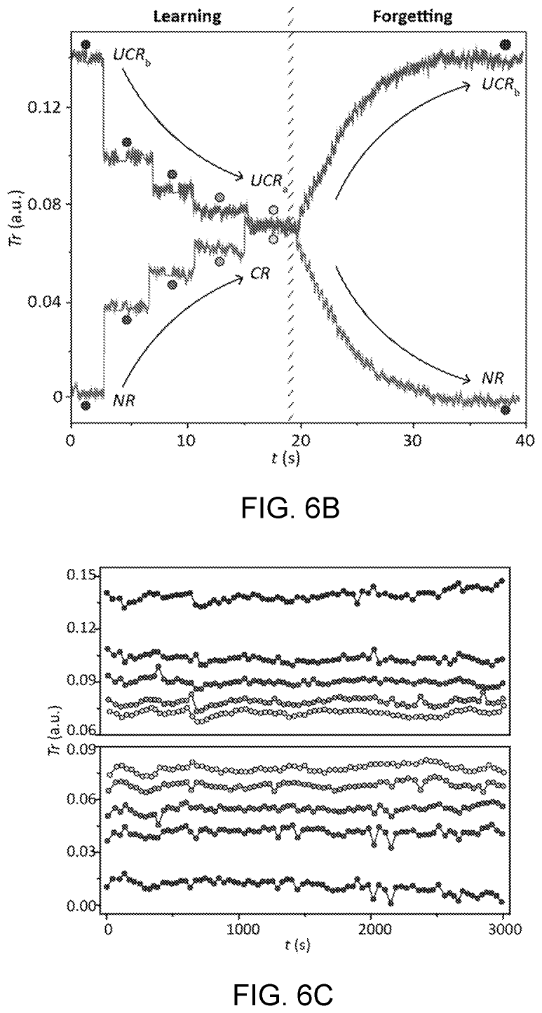

Experimental results are presented in FIGS. 6A-6C. The PCM 206 starting point is its fully crystalline state. This may be achieved by annealing on a hotplate at ˜250° C. for 10 min to completely crystallize the PCM, and then stabilize the PCM states. To implement associative learning in real-time, the output transmission readouts were probed while sending UCS and/or NS/CS input pump pulses to the element 200. FIG. 6A shows the measured probe readouts Tr (bottom) when UCS input pump pulse (top) and/or NS/CS input pump pulse (centre) were sent into the element. The points in the transmission plot (bottom) denote the readouts Tr when the UCS and NS/CS probe inputs were applied. To quantitatively describe the measurement changes, any subsequent changes of the readouts ΔTr=Tr−Tr₀ to the respective baselines Tr₀ were normalized (Tr₀˜0.14 for UCS input probe incidence and T₀˜0 for NS/CS input probe incidence). Readouts above Tr˜0.05 are designated for the presence of output response UCR/CR. This experiment is analogous to Pavlov's dog experiment, as indicated by the icons FIG. 6A.

At the start of the experiment, UCS pump input pulses at 14.5 mW power were sent into the learning element 200 (in the first waveguide 202) in events 1 and 2. It was observed that the readouts remained at the baselines. The readouts likewise remained the same when only NS pump input pulses at 14.5 mW power were sent into the learning element 200 (in the second waveguide 204) in events 3 and 4. However, when both UCS and NS pump pulses were sent together with a fixed phase delay (according to this example, Δt=0.825 fs) at 6.6 mW each (13.2 mW total) in event 5, the transmission change (ΔTr Tr₀) for the UCS and NS probe readouts changed by ˜−4% and ˜+4% respectively. As the input pump pulse power was increased from 6.6 mW to 14.5 mW each in events 6-8, the probe readouts further changed by nearly −7% and +7% respectively, both of which were well above the UCR/CR response threshold at Tr˜0.07. The experiment confirms the association of input NS/CS (analogous to the ringing bell in Pavlov's dog experiment) to input UCS (analogous to the food in Pavlov's dog experiment) through its output CR which is the learned response from UCR (analogous to salivation in Pavlov's dog experiment), after the temporal pairing of UCS and NS pump inputs in events 5-8 that caused the PCM to switch towards a more amorphous state (in contrast to that in events 1-4).

The reversibility of the associative learning process is further shown in FIGS. 6B and 6C. A set of 100 ns-wide pulses at 4.3 mW were used, each for ten times in event 9, followed by five 1.9 mW 100 ns-wide pulses each at 1 MHz repetition rate for ten times in event 10. At the end of this ‘forgetting’ process, the readouts Tr reverted to the baselines (Tr₀˜0.14 for UCS input probe and Tr₀˜0 for NS/CS input probe). FIG. 6B shows a single cycle of the real time UCR/CR output readout of associative learning in events 5-8 and forgetting process in events 9-10 of FIG. 6A. The long-term durability of the element was tested by subjecting it to 80 learning cycles, examined over a period of 40 minutes. Even after the 80 cycles, shown in FIG. 6C, the individual learning weights were clearly identifiable with deviation of each weights below 0.69% in readout transmission.

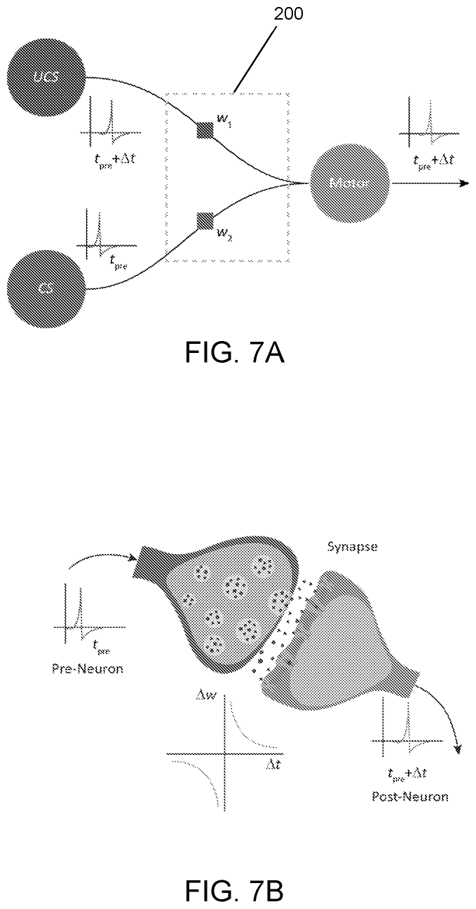

With reference to FIGS. 7A and 7B, as with the input-output relation of a single artificial synaptic connection, the input-input relation (UCS input-NS/CS input) of the associative learning element 200 according to the present disclosure is sensitive to the relative delay/phase Δt of the input pump optical fields (typically on the femtosecond scale, i.e. 10⁻¹⁵ s). As shown in FIG. 7A, the associative learning process is realized entirely on a single element 200 within which the UCS connection synaptic weight w₁ and NS/CS connection synaptic weight w₂ are simultaneously yet independently modified only when the two inputs arrive together depending on Δt. This Δt-dependent process is analogous to the spike-timing-dependent plasticity (STDP) of a biological synapse, shown in FIG. 7B, which is the requisite of memory and learning functions in the human brain. From the STDP rule, the motor neuron has the same firing timing (tₚᵣₑ+Δt) with that of UCS due to the strong synaptic weight w₁, while the firing timing of NS/CS is tₚᵣₑ. The associative learning process could be simplified as the strengthening of w₂ by pairing the UCS and NS/CS signals adjusted at a specific Δt, where Δt is also the relative timing delay between the pre-synaptic and post-synaptic neuronal spikes respectively.

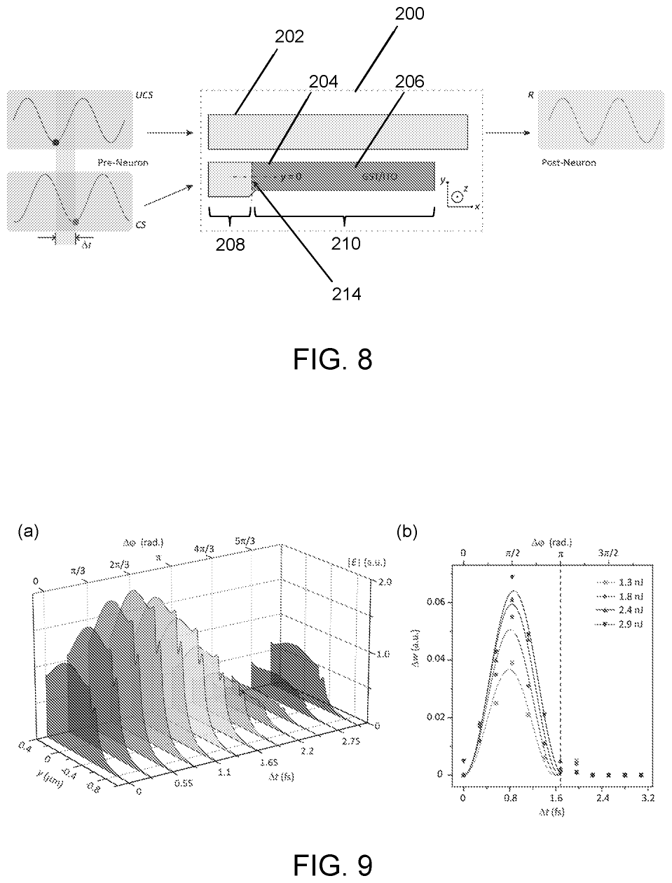

It should be appreciated that in embodiments, Δt influences the accumulated optical pump field at the interface 214 between the first 208 and second 210 directional couplers of the learning element 200. FIG. 8 illustrates a schematic of the two input fields UCS and CS incident onto the learning element 200, and highlights the representation of Δt. To investigate how Δt defines the learning readouts, the cross-sectional intensity |E|² at the interface 214 between the first 208 and second 210 directional couplers in the second waveguide 204 was numerically simulated and the NR/CR readouts (from the output of the first waveguide 202) at specific Δt values were experimentally measured. The simulation results are shown in FIG. 9, panel (a), and reveal that the maximum intensity distribution is at Δt=0.825 fs. This is consistent with the maxima in the trigonometric model which was fitted to the experimental data shown in FIG. 9, panel (b), which is attributed to the Δt-dependent accumulated field at the interface 214 in the second waveguide 204, which correspondingly modulates the PCM 206 structural states. It should be appreciated that Δt=0.825 fs is one exemplary delay which maximizes the intensity at the interface 214 for the particular parameters used in the simulation. This may vary depending on a number of parameters such as the optical wavelength, waveguide material and structure and the material used for the modulating element.

The Δt-dependence on the coupling provides greater on-demand control to generalize, discriminate and scale the pulse wavelengths that can induce the learning process, when both inputs are sent to the learning element 200. Given the sinusoidal/modular nature of Δt, sending both the pump pulses can produce the same output probe response at a set of predetermined regularly-spaced wavelengths, in contrast to single-input incidence case. The wavelength-insensitive feature of the element upon single-input incidence is due to the non-temporally resonant cascaded structures (i.e. the cascaded first 208 and second 210 directional couplers) that make up the element, whose broadband response is limited only by the change in coupling strength as the wavelength is varied. The timing-dependent plasticity of the associative learning element is consistent with the STDP rule albeit at a different order, thus permitting the associative implementation of input-input temporal contiguity in photonic neuromorphic systems.

Table 1 summarizes the minimum active volume and learning energy of other associative learning devices, except that of the synthetic biological genetic device which cannot be determined. These known electronic and optoelectronic associative learning devices range from ˜0.1 to 10¹⁰ μm³ in active volume and consume ˜2.63 to 105 nJ of energy per learning event. In comparison, the all-optical associative learning element 200 according to the present disclosure exhibits favourable characteristics in terms of dimensions and energy usage, with a low active volume at 0.12 μm³ and minimum learning energy at 1.8 nJ. In an embodiment, the single-element device is of 3 μm×17 μm area dimensions.

TABLE 1
active volume and learning energy of associative learning devices

| | Active volume | Min. learning energy |
|---|---|---|
| Type | (μm³) | (nJ) |
| Electronic | | |
| Memresistive | | |
| i. Chalcogenide | 0.2-15 | 4.7 × 10⁴ |
| | 8 | 2.63 |
| ii. Manganite | ~0.1 | 1.35 × 10³ |
| | 1.25 × 10¹⁰ | 1.02 × 10⁵ |
| iv. Nickelate | 4.7 × 10³ | 7.20 × 10⁵ |
| | 4.8 × 10⁴ | 2.04 × 10⁵ |
| v. Metal oxide | 900 | 4.5 × 10³ |
| vi. Organic | ~0.5 | 9.75 × 10³ |
| Electrochemical | 6 × 10³ | 6 × 10⁴ |
| | 9.6 × 10⁵ | 125 |
| Memcapacitive | 80.7 | ~30 |
| Optoelectronic | 1.62 × 10³ | ~2.1 × 10³ |
| Learning element of | 0.12 | 1.8 |
| the present disclosure | | |

The associative learning element 200 of the present disclosure may be employed as a building block in artificial neural networks, with reduced energy consumption, as is apparent from the data presented in Table 1. Conventional artificial neural networks on the Hebbian learning rule adopt the backpropagation algorithm, with an inherent nonlinear scaling (O(N²˜N³)) of computational effort with the synaptic connection number N. In contrast, the computational effort in neural networks that are built on associative learning scales linearly (O(N)) with N (see U.S. Pat. No. 5,588,091). Considering the typically large training input datasets required to solve a particular machine learning task, it follows that the number of iterations needed to achieve convergence can be significantly reduced by using associative learning elements; thus substantially downscaling the training time and energy usage of neural network. Therefore it should be appreciated that the present disclosure also provides photonic neural networks built on the optical associative learning element 200 according to the present disclosure, with applications in noisy pattern recognition and classification, for example.

The relation between the learning element 200 output response R and input stimuli S can be expressed in the compact matrix notation R=M_{(II)} M_{(I)} S, where the 2×1 column vector S=(UCS, NS/CS)^{T}, while the 2×2 and 1×2 matrices that describe the first 208 and second 210 directional couplers respectively are given by:

$${M}_{( I )} = ( \begin{matrix}cos ( κ {l}_{1} ) & i sin ( κ {l}_{1} ) \\ i sin ( κ {l}_{1} ) & cos ( κ {l}_{1} )\end{matrix} ) \qquad ( 1 )$$

$${M}_{( II )} = \{ \begin{matrix}\frac{{e}^{- κ {l}_{2} co sh {θ}_{b}}}{sin h {θ}_{b}} ( \begin{matrix}sinh ( κ {l}_{2} sinh {θ}_{b} + {θ}_{b} ) & i sinh ( κ {l}_{2} sinh {θ}_{b} ) ) ,\end{matrix} & before learning \\ \frac{{e}^{- κ {l}_{2} si n {θ}_{a}}}{cos {θ}_{a}} ( \begin{matrix}cos ( κ {l}_{2} cos {θ}_{a} - {θ}_{a} ) & i sin ( κ {l}_{2} cos {θ}_{a} ) ) ,\end{matrix} & after learning\end{matrix} \qquad ( 2 )$$

in which s is the waveguide mode coupling coefficient, θ_{b}=cosh⁻¹(γ_{crys}/4κ), θₐ=sin⁻¹(γₐₘ/4κ), l₁ is the length of the first directional coupler 208 and l₂ is the length of the second directional coupler 210.

In the first directional coupler 208, when two identical inputs E₀ of the same wavelength λ₀ are sent into the learning element 200, the total field coupled to the respective waveguides at the interface 214 between the first 208 and second 210 directional couplers is the product of matrix M_{(I)} and column vector (e^{-ωΔt}, 1)^{T}, where ω=(2πc/λ_{eff}), c is the vacuum speed of light, λ_{eff}=λ₀/n_{eff} is the effective wavelength in the waveguide, and n_{eff} is the effective refractive index in the waveguide. It follows that the field intensity at the second waveguide 204 at the interface 214 is |Eₗ₁|²_{two}=E₀² (1+sin(2κl₁) sin(ωΔt)). In comparison, for one-input incidence, the coupled field intensity is |Eₗ₁|²ₒₙₑ=E₀² sin²(κl₁). Thus, the critical coupling (maximum energy transfer) length of the first directional coupler 208 is l_{crit}=π/κ for one-input incidence and l_{crit}/2 (at ωΔt=π/2) for two-input incidence. Given κ=0.157 μm⁻¹ in embodiments of the present disclosure, this gives |Eₗ₁|²_{two}=1.588 (for ωΔt=π/2) and |Eₗ₁|²ₒₙₑ=0.095 at l₁=2 μm. From a PCM 206 switching energy threshold perspective, the ratio |Eₗ₁|²_{two}/(1−|Eₗ₁|²ₒₙₑ)=1.755 is indicative of associative learning because of the significant energy surplus upon two-input incidence relative to the maximum energy from one-input incidence.

In the second directional coupler 210, the relative change in output response R, which is measured for one-input incidences, can be estimated largely based on M_{(II)} because |Eₗ₁|²ₒₙₑ in the first cascade (l₁=2 μm) is negligibly low. Thus, the ratio η=R_{NS/CS}/R_{UCS}|² can be approximated as η≈|M_{(II)12}/M_{(II)11}|². This leads to η_{b}≈|sinh (κl₂ sinh θ_{b})/sinh (κl₂ sinh θ_{b}+θ_{b})|² and ηₐ≈sin(κl₂ cos θₐ)/cos (κl₂ cos θₐ−θₐ)|² (subscript ‘b’ and ‘a’ denote before and after learning). Additionally, the output transmission difference between UCR_{b} and UCRₐ can be denoted as Δ|R|²=|M_{(II)11b}|²−|M_{(II)11a}|² where the alphabetic subscripts likewise denote the learning states. Given γ_{crys}=7.65κ and γₐₘ=0.24κ according to the present disclosure, η_{b}≈0.072 and ηₐ≈1.006 at l₂=15 μm. Therefore it is possible to attain η_{b}<<ηₐ due to the unbounded sinh and positive unbounded cosh functions which cause η_{b}→0 with the substantially large γ_{crys}. The set of relations η_{b}<<ηₐ and ηₐ≈1 is the second signature of associative learning because the output R upon NS/CS input incidence transitions from a significantly low value (η_{b}<<ηₐ) to that of UCS (ηₐ≈1) which remains within the same transmission range (Δ|R|²<0.5).

In embodiments, the optical associative learning element 200 was fabricated on a Si₃N₄/SiO₂ platform. Electron beam lithography (JEOL 5500FS, JEOL Ltd.) was used at 50 kV to define the Si₃N₄ structure on the Ma-N 2403 negative-tone resist-coated substrate. After the development process, reactive ion etching (PlasmaPro 80, Oxford Instruments) was performed in CHF₃/O₂/Ar to etch down 330 nm of Si₃N₄. A subsequent step of electron beam lithography was implemented on a poly(methyl methacrylate) (PMMA) positive resist-coated substrate to open a window for the PCM cell. This was followed by the sputter-deposition of 10-nm GST/10-nm ITO on the substrate. The element characterization process was performed using a high resolution emission gun SEM (Hitachi S-4300 SEM system—Ibaraki, Japan) with low accelerating voltage (1 to 3 kV) at a working distance of ˜13 mm.

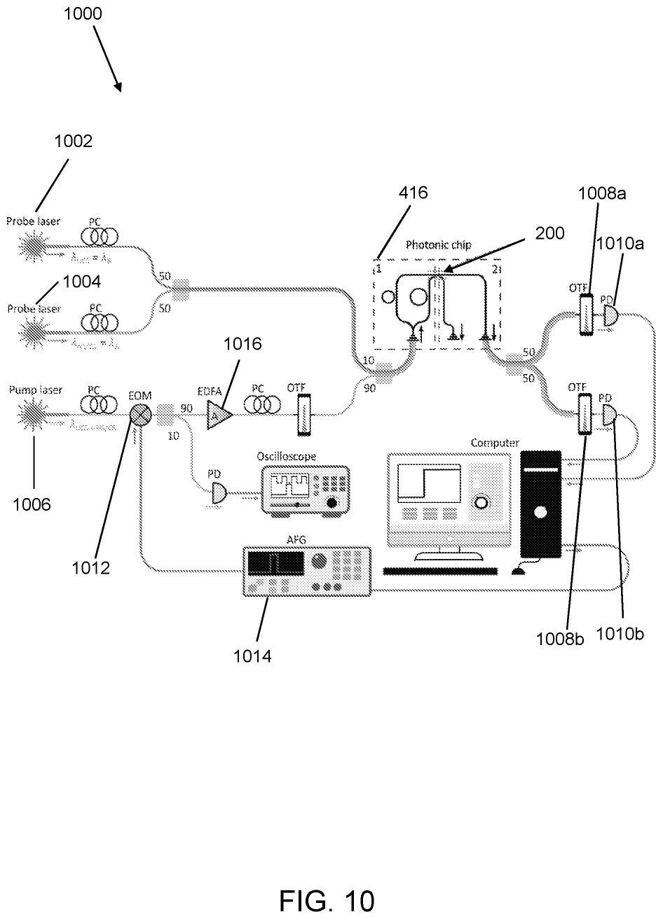

An exemplary optical setup 1000 employing an optical associative learning element 200 according to the present disclosure is illustrated schematically in in FIG. 10. First 1002 and second 1004 low-power probe lasers and a high-power pump laser 1006 all having different emission wavelengths are routed through the learning element 200 in the same direction. This is achieved by combining light from the three lasers into a common spatial mode and coupling the combined mode into the photonic chip 416 which includes the learning element 200. To measure the probe signals after the signals pass through the element, the paths were split into two, filtered by band-pass filters 1008a,b (OTF-320, Santec Corp.) and detected by optical detectors 1010a,b (2011-FC, Newport Spectra-Physics Ltd.). Two continuous-wave (CW) diode lasers (N7711A, Keysight Technologies) were used as probe lasers 1002, 1004 to measure the transmission through the element 200. The pump pulse was generated from a CW diode laser 1006 (TSL-550, Santec Corp.) modulated by an electro-optic modulator 1012 (EOM) (2623NA, Lucent) which was in turn controlled by an electrical arbitrary pulse generator 1014 (AFG 3102C, Tektronix), and then amplified by a low-noise erbium-doped fiber amplifier 1016 (AEDFA-CL-23, Amonics). In a stabilization step carried out prior to the experiment, a set of amorphizing pulses were sent to the learning element 200, followed by a set of crystallizing pulses. These sets of pulses are exactly the same as the pulses applied during the ‘associative learning’ and ‘forgetting’ process described above with reference to FIGS. 6A-6C in which the set of amorphizing pulses is the consecutive 100 ns-wide pulses at 6.6 mW, 8.7 mW, 12.6 mW and 14.5 mW, while the set of crystallizing pulses is the 100 ns-wide pulse at 4.3 mW for ten times, followed by five 1.9 mW 100 ns-wide pulses at 1 MHz repetition rate for ten times.

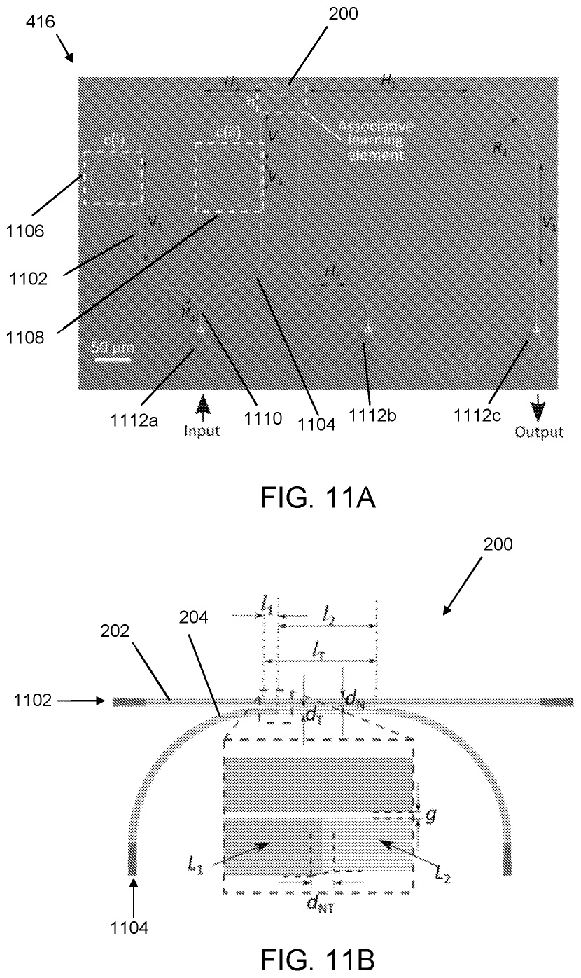

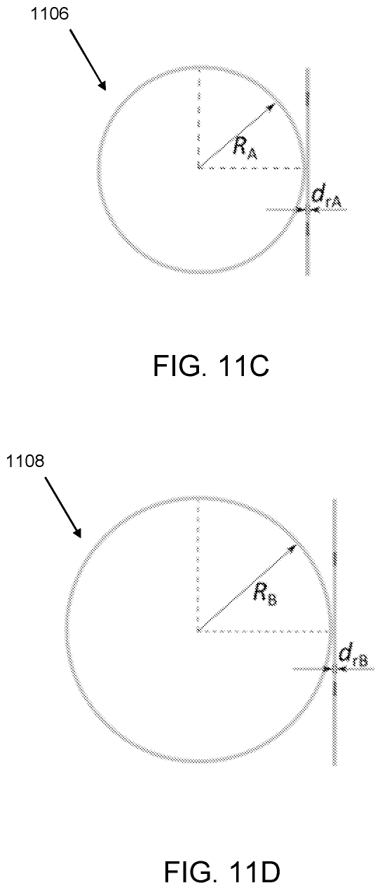

FIGS. 11A-11D illustrate in more detail an on-chip photonic layout/platform 416 including an associative learning element 200 according to the present disclosure. First and second spatial paths 1102 and 1104 formed from waveguides on the chip are coupled to the first 202 and second 404 waveguides of the associative learning element 200. The light propagating through the first and second spatial paths is optionally regulated by two ring resonators 1106, 1108 respectively and evenly divided from a single point by an optical splitter 1110. To couple light between a fiber array and the planar on-chip structure, three on-chip apodized grating couplers 1112a-c are integrated on the structure. In the illustrated example, the grating couplers are spaced 250 μm apart to correspond to the pitched distance of the fiber array units. The on-chip layout 416 enables the on/off regulation of the input fields and allows the time delay of the phases to be precisely defined. Exemplary dimensions of the parameters specified in FIGS. 11A-11D are summarized in Tables 2-4.

TABLE 2
parameters of on-chip layout

| | Dimension | | Dimensions |
|---|---|---|---|
| Parameter | (μm) | Parameter | (μm) |
| V₁ | 150 | H₂ | 242.5 |
| V₂ | 73.5 | H₃ | 12.35 |
| V₃ | 39 | R₁ | 45 |
| H₁ | 78.5 | R₂ | 100 |

TABLE 3
parameters of learning element

| | Width | | Length |
|---|---|---|---|
| Parameter | (μm) | Parameter | (μm) |
| dₙ | 1.1 | l_{T} | 17 |
| d_{T} | 1.0 | l₁ | 1.75 |
| d_{nT} | 0.5 | l₂ | 14.75 |

TABLE 4
parameters of ring resonators

| | Radius | | Width |
|---|---|---|---|
| Parameter | (μm) | Parameter | (μm) |
| R_{A} | 35 | d_{rA} | 0.85 |
| R_{B} | 45 | d_{rB} | 0.9 |

In some embodiments, the optical associative learning element 200 consists of two cascaded optical directional couplers 208 and 210. For brevity and consistency, these are referred to as cascade I and II in the following paragraphs. The directional couplers, made up of two parallel channel optical waveguides 202 and 204 in close proximity, allow optical energy exchange between the guided modes of adjacent waveguides. The lower waveguide 204 of cascade I (segment L₁) is the site where optical energy from the UCS and NS/CS inputs accumulate for PCM 206 structural phase switching to occur at the lower waveguide 204 of cascade II (segment L₂), thus regulating the output response R of the element 200.

For the case of a lossy bottom waveguide with similar propagation constants, one can theoretically treat the optical modes in the element starting from the coupled-mode equations da/dx=iκb and db/dx=iκa−(γ/2)b where the normalized x-direction spatially dependent mode amplitudes of the coupled upper and lower waveguides are denoted by a and b; κ is the coupling coefficient, and γ is the loss coefficient of mode b due to the PCM. To ensure the relevance of these equations, the difference in propagation constant is compensated by tapering the second waveguide 204 on which the PCM patch 206 is deposited, which is comparable to using a lossy material with diminishing real permittivity in passive parity-time symmetric directional couplers. Because cascades I and II are respectively without and with the PCM 206, the modes in cascade II are first solved for and then conveniently it is possible to obtain the solution for cascade I by letting γ→0, before cascading both matrices to solve for the output R with respect to the UCS and NS/CS inputs.

For γ/4κ≤1, given the [−1, +1] range of a sine function, let γ/4κ=sin θ to arrive at

$$( \begin{matrix}a \\ b\end{matrix} ) = \frac{{e}^{- κ x si n θ}}{cos θ} ( \begin{matrix}cos ( κ x cos θ - θ ) & i sin ( κ x cos θ ) \\ i sin ( κ x cos θ ) & cos ( κ x cos θ + θ )\end{matrix} ) ( \begin{matrix}{a}_{0} \\ {b}_{0}\end{matrix} ) , \frac{γ}{4 κ} \leq 1 \qquad ( 3 )$$

where a₀ and b₀ are the fields a(x=0) and b(x=0) which we relate to the general notations a(x) and b(x) after applying initial boundary condition to the equations. For γ/4κ≤1, let γ/4κ=cosh θ given [1, =∞] range of a hyperbolic cosine function. Following through the same procedure, this gives

$$( \begin{matrix}a \\ b\end{matrix} ) = \frac{{e}^{- κ x co sh θ}}{sinh θ} ( \begin{matrix}sinh ( κ x sinh θ + θ ) & i sinh ( κ x sinh θ ) \\ i sinh ( κ x sinh θ ) & sinh ( κ x sinh θ - θ )\end{matrix} ) ( \begin{matrix}{a}_{0} \\ {b}_{0}\end{matrix} ) , \\ \frac{γ}{4 κ} > 1 \qquad ( 4 )$$

From equation 3 the input-output relation of cascade I is obtained by letting γ→0.

To describe the output R as a function of the inputs UCS and CS, one can multiply the 2×2 matrix in equation 3 after letting γ→0 for cascade I by that of equation 3 when γ/4κ≤1 or equation 4 when γ/4κ>1 for cascade II. The 2×2 matrix in cascade II can be reduced to a 1×2 matrix because only the output field on the upper waveguide 202 of cascade II represents the output R. The equation for the overall system can thus be concisely written as R=M_{(II)} M_{(I)} S where S=(UCS, NS/CS)^{T} is the column vector that denotes the respective inputs to the element while the matrices M_{(I)} and M_{(II)} respectively describe the optical coupling tendencies in the cascaded sections of the lengths x=l₁ and x=l₂.

$${M}_{( I )} = ( \begin{matrix}cos ( κ {l}_{1} ) & i sin ( κ {l}_{1} ) \\ i sin ( κ {l}_{1} ) & cos ( κ {l}_{1} )\end{matrix} ) \qquad ( 5 )$$

$${M}_{( II )} = \{ \begin{matrix}\frac{{e}^{- κ {l}_{2} si n θ}}{cos θ} ( \begin{matrix}cos ( κ {l}_{2} cos θ - θ ) & i sin ( κ {l}_{2} cos θ )\end{matrix} ) , & \frac{λ}{4 κ} \leq 1 \\ \frac{{e}^{- κ {l}_{2} co s h θ}}{sinh θ} ( \begin{matrix}sinh ( κ {l}_{2} sinh θ + θ ) & i sinh ( κ {l}_{2} sinh θ ) ) ,\end{matrix} & \frac{γ}{4 κ} > 1\end{matrix} \qquad ( 6 )$$

in which θ=sin⁻¹(γ/4κ) when γ/4κ≤1 and θ=cosh⁻¹(γ/4κ) when γ/4κ>1. Here, the inputs to the first and second cascades are respectively at x₁=0 and x₂=0.

From eigenmode simulations of the structure, estimates of the parameter values were obtained as x=0.157 μm⁻¹, γ_{crys}=7.65κ and γₐₘ=0.24κ using the eigenvalue splitting equation Δβ_{±}=2i (κ²+(γ/4κ)²)^{1/2} which directly follows from the coupled mode equations, where γ_{crys} and γₐₘ are the loss coefficient γ when the PCM is at crystalline and amorphous structural phases. Because γ_{crys}/4κ>1 and γₐₘ/4κ≤1, equation 5 and equation 6 can be written respectively as equations 1 and 2 above.

When two optical inputs of the same magnitude E₀ and wavelength λ₀ are launched into the element 200, the total field coupled to the respective waveguides at L₁ is scaled by the product of matrix M_{(I)} and column vector (e^{-iωΔt} 1). The inputs to the element can thus be rewritten as a₀=E₀e^{-ωΔt} and b₀=E₀ where the angular frequency ω=(2πc/n_{eff} λ₀), c is the vacuum speed of light, and n_{eff} is the waveguide effective refractive index. It follows that the field coupled to the lower and upper waveguide in the first cascade are respectively given by

|Eᵤₚₚₑᵣ|²=|E₀e^{-iωΔt}M_{(I)11}+E₀M_{(I)12}|²=E₀²(1−sin(2κl₁)sin(ωΔt)) (7)

|E_{lower}|²=|E₀e^{-ωΔt}M_{(I)21}+E₀M_{(I)22}|²=E₀²(1+sin(2κl₁)sin(ωΔt)) (8)

At κl₁=π/4 when ωΔt=π/2, it follows that the field coupled to the upper and lower waveguide are respectively 0 and 2E₀, which is indicative of two-input critical coupling. This implies that the two-input critical coupling length at l₁=π/4κ is half the single-input critical coupling length at l₁=π/2κ.

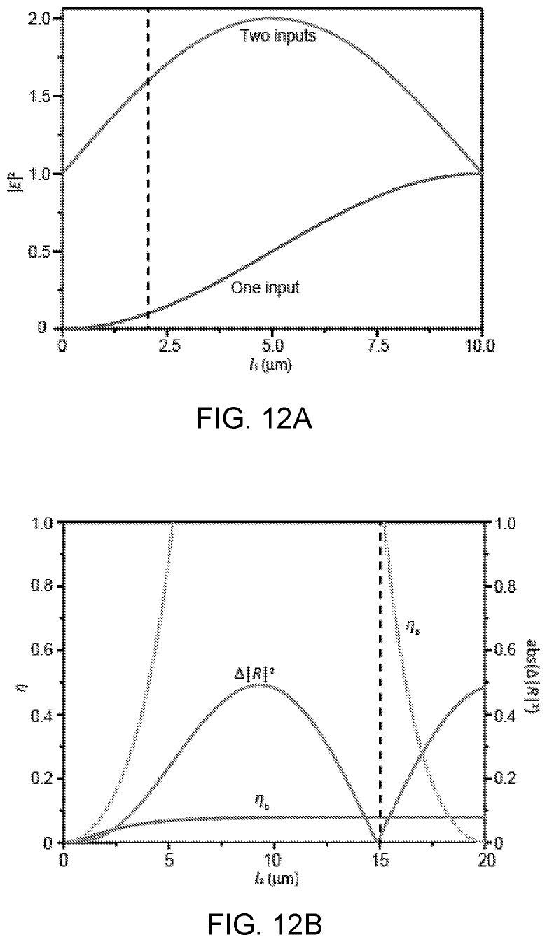

With reference to FIGS. 12A and 12B, coupled-mode theory with estimated κ and γ values was used to ascertain exemplary values for the length l₁ of the first directional coupler 208 and the length l₂ of the second directional coupler 210. Because the element should associatively learn only upon two-input incidence and the regulation of R (which is measured upon one-input incidences) is allocated to the second coupler 210 of the cascade of first and second couplers, it is desirable that ‘two-input coupling’ to the interface 214 between the first 208 and second 210 couplers in the second waveguide 204 is enhanced and ‘one-input coupling’ is impeded by exploiting the critical coupling length contrast between the one-input case lcm and two-input case l_{Crit}/2. FIG. 12A shows the intensity |E|² at the interface 214 in the second waveguide for different lengths l₁ of the first directional coupler. An optimal value of l₁=2 μm is determined, as shown by the dotted line in FIG. 12A. The impeded ‘one-input coupling’ in the first cascade allows a ratio η=|_{RNS/CS}/R_{UCS}|² to be approximated solely from the second directional coupler 210 η≠M_{(II)12}/M_{(II)11}|². This leads to η_{b}≈|sinh (κl₂ sinh θ_{b})/sinh (κl₂ sinh θ_{b}+θ_{b})|² before learning (denoted by subscript ‘b’) and ηₐ≈|sin (κl₂ cos θₐ)/cos (κl₂ cos θₐ−θₐ)|² after learning (subscript ‘a’), where θ_{b} is the case when γ/4κ>1 and θₐ when γ/4κ≤1. In addition, the output transmission difference between UCR_{b} and UCRₐ is denoted as Δ|R|²=|M_{(II)11b}|²−|M_{(II)11a}|² where the alphabetic subscripts likewise denote the learning states. From this, a length of the second directional coupler of l₂=15 μm, shown by the dotted line in FIG. 12B, was determined such that the output R upon NS/CS input incidence transitions from a significantly low value (η_{b}<<ηₐ) to that of UCS (ηₐ≈1), in which the outputs due to UCS remain relatively within the same transmission range (Δ|R|²<0.5).

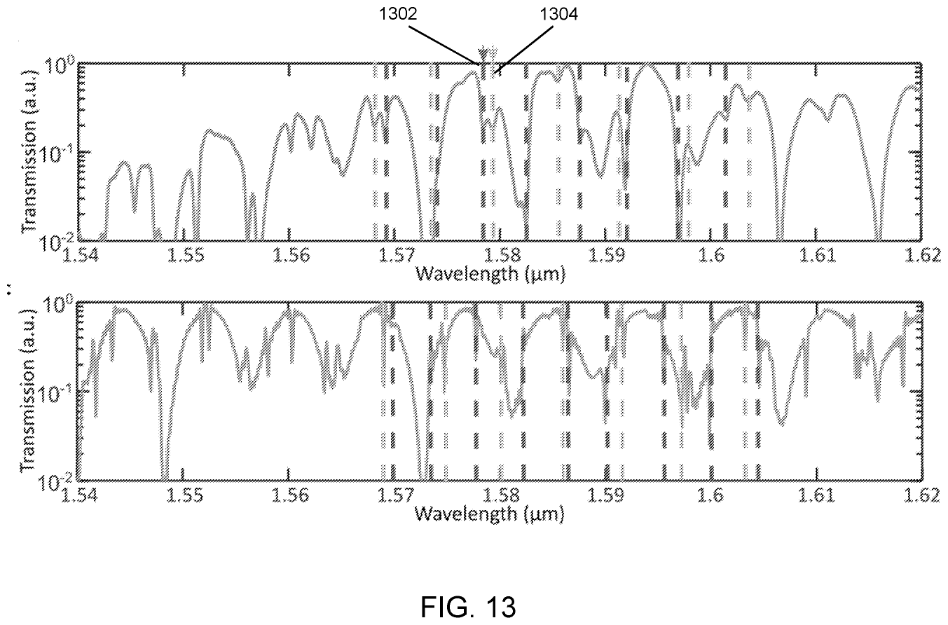

To conveniently turn on/off the UCS (NS/CS) input and to precisely define the time delay of the phases between the UCS (NS/CS) inputs, the associative learning element 200 is integrated on an on-chip structure 416 as described above. When the input to the on-chip structure is of ring B (A) resonant wavelength λ_{B} (λ_{A}), the UCS (NS/CS) inputs are incident to the associative learning element 200. FIG. 13 highlights λ_{A} and λ_{B} in the transmission spectrum of the output response R, denoted by the dark grey 1302 and light grey 1304 dashed lines respectively. The arrows denote the λ_{A} and λ_{B} wavelengths at which measurements were carried out for UCS and NS/CS single input incidences. The probe measurements were performed at these wavelengths (λ≈1.58 μm) after ensuring that ring resonators A and B were critically coupled to the tapered waveguides. This was confirmed by measuring two adjacent waveguide-ring resonator structures (not shown) of the same dimensions. The free spectral range of the resonances in our experiments matches with that of simulations.

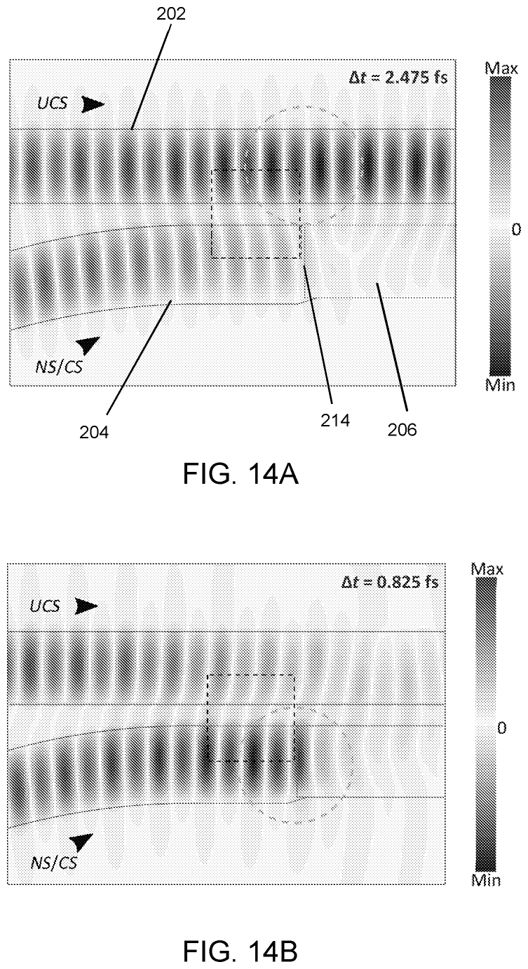

While the single-input probe readouts are carried out at the resonant wavelengths λ_{A} and λ_{B}, the two-input pump signals (which induce associative learning) are let incident at the non-resonant wavelengths of the ring resonators. The time delay between the inputs Δt can be conveniently defined from the spectrum in FIG. 13. The spectrum fringes are attributed to the change in Δt with wavelength, given that the transmission spectrum was measured from the on-chip layout of fixed spatial dimensions. These fringes provide a convenient means to precisely define Δt in the experiments. To elucidate the Δt-dependent coupling tendency of the two inputs, numerical simulations were performed of the structure upon two-input incidence at differing Δt. Results of these simulations are shown in FIGS. 14A and 14B and indicate that when Δt=2.475 fs and Δt=0.825 fs, the net field at the interface 214 of the learning element 200 tends towards the first 202 and second 204 waveguide respectively (denoted by the dashed circles).

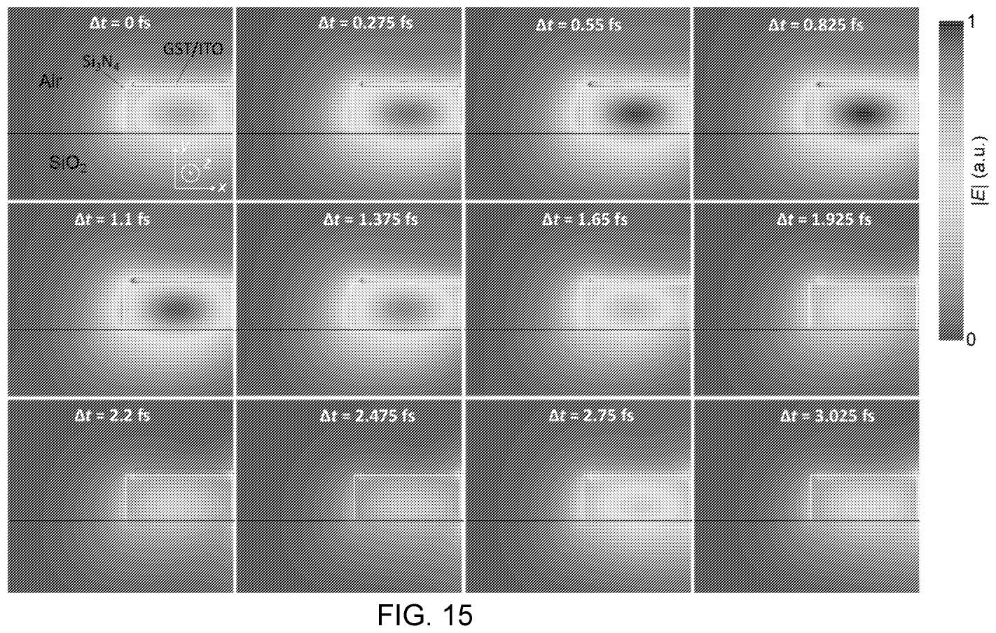

The simulation results can be further corroborated by equations 7 and 8, which give |E_{L1}|²_{lower}→0 when Δt=2.475 fs at x₂=5 μm and |E_{L2}|²_{lower}→1.588 when Δt=0.825 fs at x₂=2 μm (at the interface 214). To compare the field magnitude at the interface 214 in the second waveguide 204, the electric field profile of the vertical cross-section was retrieved, shown in FIG. 15. The profiles confirm that the net |E| is maximum at Δt=0.825 fs and minimum at Δt=2.475 fs. Because the change in response weight Δw occurs when the coupled accumulated field at the interface 214 in the second waveguide 204 sufficiently switches the PCM 206 structural phase, according to this example the learning process is induced when the inputs are let incident at ˜Δt=0.825 fs.

In FIG. 9, panel (b), the data points of the NS/CS connection synaptic weight Δw were fitted to the trigonometric expression A_{f}×(1−cos(ω_{f}×Δt)) where A_{f} is the normalized amplitude of the fitted Δw curve and ω_{f} is the fitted angular frequency of the curve. Table 5 shows the fitted values of A_{f} and ω_{f} for the specified UCS and NS/CS pump energies. Here, the fitted ω_{f} is comparable to 2π×0.825 fs=1.65×10¹⁵ π rads⁻¹, where 0.825 fs is the Δt range at which the two-input coupled field |E| at the interface 218 is at least that of one-input incidence, see FIG. 9, panel (a). The form of the fitted equation resembles the trigonometric basis of Equations 7 and 8, with fitting deviation due to the nonlinear switching threshold of the PCM.

TABLE 5
Fitting parameters of input-input synaptic weight

| Fitting Model and Parameters | | FIG. 9, panel (b) (different pump energies) | | | |
|---|---|---|---|---|---|
| A_{f} × (1 − cos(ω_{f} × Δt)) | | 1.3 nJ | 1.8 nJ | 2.4 nJ | 2.9 nJ |
| A_{f} | Mean | 0.01836 | 0.02529 | 0.02972 | 0.03204 |
| | Std. | 0.00153 | 0.00134 | 0.00137 | 0.00133 |
| | deviation | | | | |
| ω_{f} (×10¹⁵ | Mean | 5.49905 | 5.36012 | 5.18749 | 5.00685 |
| rads⁻¹) | Std. | 0.05849 | 0.0383 | 0.03369 | 0.02976 |
| | deviation | | | | |

| | | | | |
|---|---|---|---|---|
| Adjusted R-squared | 0.90708 | 0.96292 | 0.9711 | 0.97621 |

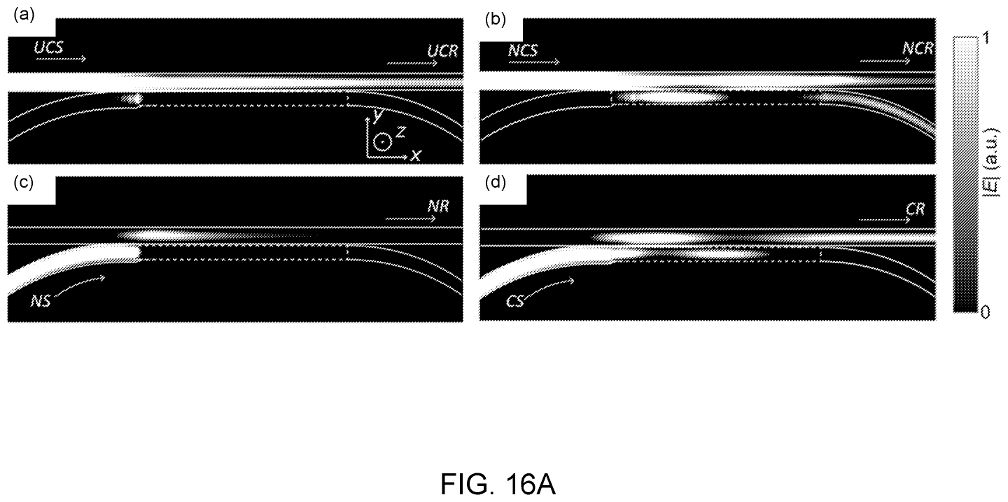

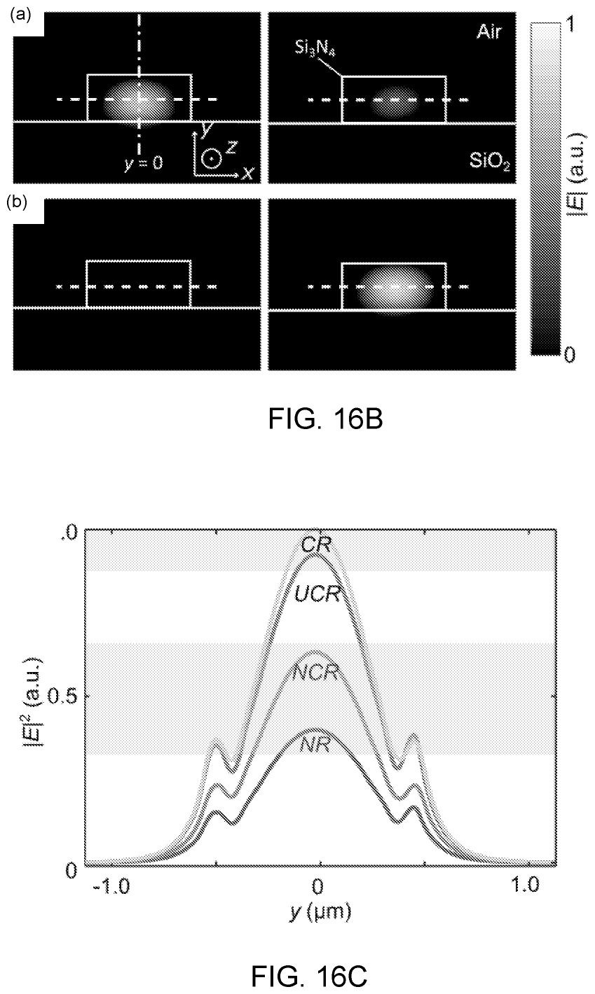

The results disclosed herein show that after the associative learning process, input CS comes to suggest input UCS, which reflects the typical one-way associative learning process NS/CS→UCS. Additionally, with reference to FIGS. 16A-16C, a two-way associative learning process NS/CS⇄UCS/NCS can also be performed on the associative learning element 200, where the NCS is the NS-like neutral conditioned stimulus. Here, after the learning process, in addition to the typical CS-UCS association, the input UCS comes to suggest the input NCS. This can be achieved by reducing the effective refractive index of the waveguide 202, 204, e.g. to a value n_{eff}=1.48, which causes the mode coupling coefficient and the effective loss coefficient, in this example, to be κ≈0.276 μm⁻¹ and (γ_{crys}, γₐₘ)≈(9.36κ, 0.52κ). For the first cascaded section 208, reducing the length of the section to l₁=1.25 μm yields |E_{L1}|²_{two}≈1.636 and |E_{L1}|²ₒₙₑ≈0.114, respectively. Therefore, χ=|E_{L1}|²_{two}/(1−|E_{L1}|²ₒₙₑ)=1.846 which is indicative of associative learning because χ>1.5. For the second cascaded section 210, η_{b}≈0.051 and ηₐ≈2.408 at l₂=15 μm implies a two-way associative learning process NS/CS⇄UCS/NCS because ηₐ>2 instead of the typical ηₐ≈1 condition for the one-way learning process.

Based on these exemplary dimensions, three-dimensional FDTD numerical simulations of the structure were performed before and after the learning process to corroborate the χ and η calculations above. FIG. 16A, panels (a)-(d), show the input NS/CS⇄input UCS/NCS association according to the simulations. In the ‘before learning’ case, shown in panels (a) and (c) of FIG. 16A, the UCS input field yields the output response UCR represented by the lighter shade at the output end of the element, in contrast to the NS input which does not yield a UCR-like response and is denoted here as the NR. On the other hand, in the ‘after learning’ case, shown in panels (b) and (d), in addition to the typical CR output response due to the CS input, the NCS input field now yields the NCR instead of the typical UCR. FIG. 16B, panels (a) and (b), shows the corresponding output cross-sectional field profile before (left) and after (right) the learning process when the UCS input (panel (a)) and NS/CS input (panel (b)) are launched to the element. The output cross-sectional curve of intensity |E|² with respect to the spatial position y=0 shows a clear contrast between the NCR/NR and CR/UCR outputs, as shown in FIG. 16C.

For optical neuromorphic computing applications that require the ability to handle rapid bursts of traffic and heavy loads with little or no notice, it is desirable to have a scalable monolithic hardware system architecture. The optical associative learning element 200 according to the present disclosure can serve as a building block in a neuromorphic network. As disclosed herein, the all-optical associative learning element 200 can be integrated onto a platform (i.e. photonic chip 416) which locks the phase difference between the UCS and NS/CS as a function of the input optical frequency after the optical input through e.g. an apodized grating coupler was divided equally by the on-chip optical splitter 418. This approach capitalizes on the fact that the all-optical associative learning element 200 consists of cascaded first 208 and second 210 directional couplers, which have been found to be robust to stimuli wavelength difference within a reasonably wide wavelength range. An all-optical phase shifter may be introduced on a first layer of the neuromorphic network. Subsequent layers may require only judicious determination of the path length between one associative learning node to another (as demonstrated herein) once the operating optical wavelength has been determined for the prospective scalable neuromorphic network. Several all-optical artificial neural network architectures based on the associative learning element 200 are disclosed herein.

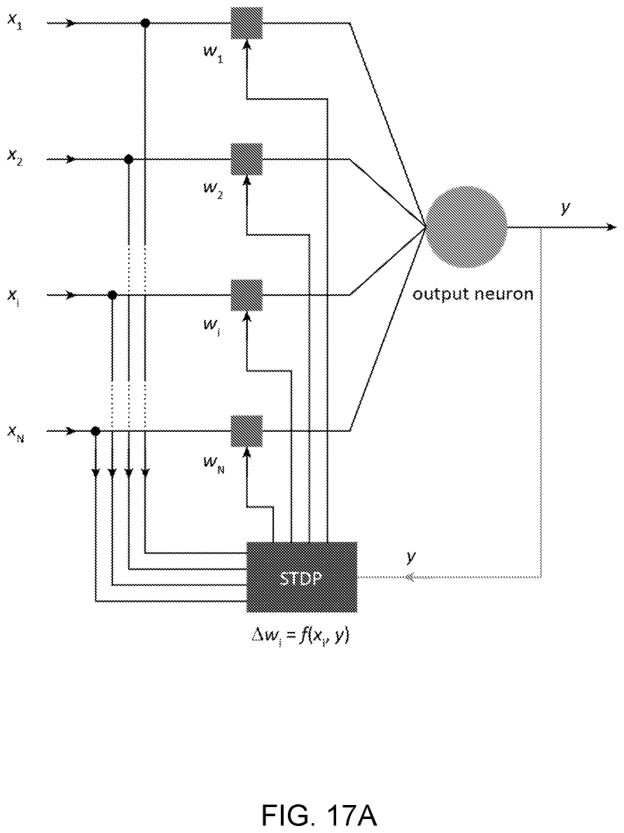

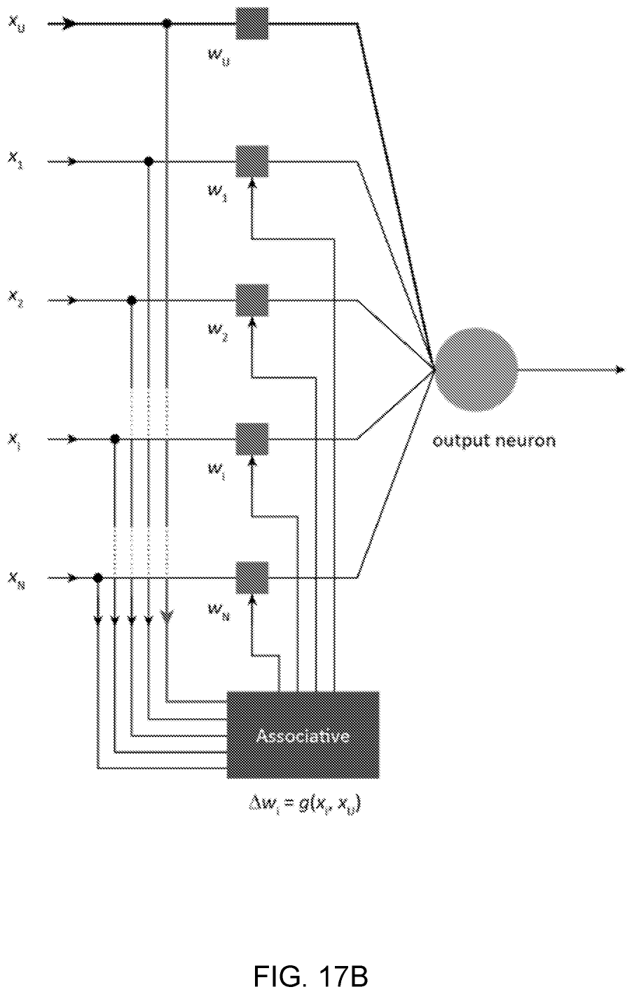

Typical artificial neural networks originate from the Hebbian learning rule, which describes how neuronal activities affect the connections between neurons i.e., biological neural plasticity. The rule states that the synaptic weight of a neural connection is adjusted based on the relative timing between the activities from two neurons on either sides of a synapse (pre-synaptic and post-synaptic activities). An example of a scheme to artificially implement the spike-based formulation of the Hebbian learning rule, known as spike-timing dependent plasticity (STDP) is shown in FIG. 17A. The weight plasticity of the synaptic connection is given by Δw=f(tₚᵣₑ−tₚₒₛₜ) where tₚᵣₑ and tₚₒₛₜ are the firing time of the pre- and post-synaptic neurons respectively. To implement Hebbian learning rule in deep learning algorithms, a backpropagation (local feedback) algorithm is necessary for the multi-layer networks. However, such implementation involves algorithms that are computationally intensive with computational complexity of O(N₂˜N³) where N is the number of synapses; and is inspired from the ‘backpropagation process’.

On the other hand, associative learning for machine learning is based on empirical evidences of the learning process in the marine snail Hermissenda crassicornis and the hippocampus of the rabbit. Inspired by the learning process in these biological neural systems, a distinctively unique type of artificial neural network based on associative learning has been proposed, with the basic neural connection shown in FIG. 17B. Here, the weight function of associative learning is Δw=g (t_{CS}−t_{UCS}), where t_{CS} and t_{UCS} are the firing time of the CS and UCS input neurons respectively. Notably, the weight adjustments in associative learning are only dependent on local input information, without requiring any information from the post-synaptic neuron. It has been shown that artificial neural networks that are explicitly based on associative learning have a computational complexity of O(N), which evidently suggests efficient computation e.g., for pattern recognition.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality and reference signs in the claims shall not be construed as limiting the scope of the claims.

1. An optical associative learning element comprising a first waveguide, a second waveguide and a modulating element, wherein:
a cascaded first and second directional coupler are formed from a portion of the first and second waveguides in which the first and second waveguides are substantially parallel, evanescently coupled and separated by a gap;
the modulating element is evanescently coupled to the second waveguide in the second directional coupler and is arranged to modify a transmission or absorption characteristic of the second waveguide dependent on the state of the modulating element; and
the state of the modulating element is adjustable between a first and second state by an optical field carried by the first and/or second waveguide.

2. The optical associative learning element according to claim 1, wherein modulating element is configured to modify the amount of coupling between the first and second waveguides in the second directional coupler dependent on the state of the modulating element.

3. The optical associative learning element according to claim 1, wherein the modulating element comprises a phase change material, the modulating element comprising a compound or alloy of a combination of elements selected from the following list of combinations: GeSbTe, VOₓ, NbOₓ, GeTe, GeSb, GaSb, AgInSbTe, InSb, InSbTe, InSe, SbTe, TeGeSbS, AgSbSe, SbSe, GeSbMnSn, AgSbTe, AuSbTe, and AlSb.

4. (canceled)

5. The optical associative learning element according to claim 1, wherein the second waveguide is tapered in the portion corresponding to the second directional coupler, such that a width of the second waveguide in the first directional coupler is greater than a corresponding width of the second waveguide in the second directional coupler.

6. The optical associative learning element according to claim 5, wherein the width of the second waveguide in the first directional coupler is in the range 1.05 μm to 1.15 μm and the width of the second waveguide in the second directional coupler is in the range 0.95 μm to 1.04 μm and the second waveguide tapers over a distance in the range 0.4 μm to 0.6 μm.

7. The optical associative learning element according to claim 1 wherein the length of the first directional coupler is in the range 1.5 μm to 3.0 μm and the length of the second directional coupler is in the range 10 μm to 20 μm.

8. The optical associative learning element according to claim 1, wherein the second directional coupler is arranged such that:
when the modulating element is in the first state, the first waveguide provides a first output intensity I₁ when an optical field having intensity I₀ is introduced into the first waveguide prior to the first directional coupler, and a second output intensity I₂ when an optical field having intensity I₀ is introduced into the second waveguide prior to the first directional coupler; and
when the modulating element is in the second state, the first waveguide provides a third output intensity I₃ when an optical field having intensity I₀ is introduced into the first waveguide prior to the first directional coupler, and a fourth output intensity I₄ when an optical field having intensity I₀ is introduced into the second waveguide prior to the first directional coupler,
wherein the magnitude of the difference between I₄ and I₃, |I₄−I₃|, is less than the magnitude of the difference between I₂ and I₁, |I₂−I₁|.

9. The optical associative learning element according to claim 8, wherein the magnitude of the difference between I₄ and I₃ is less than or equal to 10% of the magnitude of the difference between I₂ and I₁, preferably less than or equal to 5% of the magnitude of the difference between I₂ and I₁, more preferably less than or equal to 1% of the magnitude of the difference between I₂ and I₁.

10. (canceled)

11. A photonic chip comprising:
the optical associative learning element according to claim 1;
an input coupler for coupling optical fields into the photonic chip; and
a splitter arranged to divide an output of the input coupler into first and second spatial paths on the photonic chip, wherein
the first spatial path is coupled to the first waveguide of the optical associative learning element and the second spatial path is coupled to the second waveguide of the optical associative learning element, and
the first and second spatial paths are arranged to introduce an optical phase delay between optical fields arriving at the first directional coupler of the optical associative learning element.

12. The photonic chip according to claim 11, wherein the optical phase delay and the first directional coupler of the optical associative learning element are arranged such that optical intensity is accumulated in the second waveguide at the interface between the first and second directional couplers of the learning element when both the first and second waveguides carry optical fields contemporaneously.

13. An optical system, comprising:
the photonic chip according to claim 11:44;
a light source coupled to the input coupler and arranged to provide optical fields to the optical assortative learning element via the first and second spatial paths; and
a detector arrangement coupled to the first waveguide of the optical associative learning element at the output of the second directional coupler thereof.

14. The optical system according to claim 13, wherein:
the light source comprises a first laser, a second laser and an optical combiner,
the first laser is arranged to produce first optical pulses having a first wavelength;
the second laser is arranged to produce second optical pulses having a second wavelength, different from the first wavelength;
the optical combiner is arranged to receive the first and second optical pulses from the first and second lasers and combine them into a common spatial mode;
an output of the optical combiner is coupled to the input coupler of the photonic chip;
the first and second spatial paths on the photonic chip comprise a first ring resonator and a second ring resonator respectively,
the first ring resonator is arranged to select said first wavelength from said first portion and the second ring resonator is arranged to select said second wavelength from said second portion; and
the outputs of the first and second ring resonators are coupled to the first and second waveguides respectively of the optical associative learning element, prior to the first directional coupler.

15. The optical system according to claim 14, wherein the detector arrangement comprises a beam splitter, a first optical tuneable filter, a second optical tuneable filter, a first photodiode and a second photodiode, wherein:
the beam splitter is arranged to split the optical intensity from the first waveguide into a first spatial mode and a second spatial mode;
the first optical tuneable filter is arranged to select the first wavelength in the first spatial mode;
the second optical tuneable filter is arranged to select the second wavelength in the second spatial mode;
the first photodiode is arranged to detect optical intensity after the first optical tuneable filter; and
the second photodiode is arranged to detect optical intensity after the second optical tuneable filter.

16. The optical system according to claim 13, further comprising a controller arranged to:
control the light source to produce a pre-determined sequence of optical fields;
receive one or more readouts from the detector arrangement; and
determine a learning status of the optical associative learning element based on the one or more readouts.

17. An optical artificial neural network, comprising a plurality of optical associative learning elements according to claim 1, wherein at least two of the optical associative learning elements are coupled together.

18. The optical artificial neural network according to claim 17, wherein the output of the first waveguide of a first one of the plurality of optical associative learning elements is coupled to the input of the first or second waveguide of a second one of the plurality of optical associative learning elements.

19. A method of performing an associative learning operation in the optical domain using a device comprising a first waveguide, a second waveguide and a modulating element, wherein:
a cascaded first and second directional coupler are formed from the portion of the first and second waveguides in which the first and second waveguides are substantially parallel, evanescently coupled and separated by a gap;
the modulating element is evanescently coupled to the second waveguide in the second directional coupler and is arranged to modify a transmission or absorption characteristic of the second waveguide dependent on the state of the modulating element,
the method comprising:
providing first and second optical fields contemporaneously to the first and second waveguides respectively thereby modifying a state of the modulating element.

20. The method according to claim 19, wherein modifying a state of the modulating element comprises changing the state of the modulating element from a more crystalline state to a less crystalline state, such as an amorphous state.

21. (canceled)

22. The method according to claim 19, further comprising selecting a relative optical phase delay between the first and second optical fields in order to maximize an accumulated optical intensity in the second waveguide at the interface between the first directional coupler and the second directional coupler.

23. The method according to claim 19, further comprising determining a learning status of the device by determining optical transmittance factors through the device for optical fields coupled to inputs of the first and second waveguides separately, wherein the device is deemed to be in a post-learning state if said optical transmittance factors are within 10% of each other.

24-25. (canceled)
